(19) United States
(12) Patent Application Publication
(10) Pub. No.: US 2010/0270810 A1
(43) Pub. Date: Oct. 28, 2010

(54) ALTERNATIVE ENERGY GENERATION SYSTEMS FOR VEHICLES

(76) Inventor: Raanan Liebermann, North Haven, CT (US)

Correspondence Address: BACHMAN & LAPOINTE, P.C., 900 CHAPEL STREET, SUITE 1201, NEW HAVEN, CT, 06510, US

(21) Appl. No.: 12/608,197

(22) Filed: Oct. 29, 2009

Related U.S. Application Data
(63) Continuation-in-part of application No. 12/428,629, filed on Apr. 23, 2009.

(51) Int. Cl. H02K 7/18; F02B 43/08; G06Q 30/00; H02K 53/00

(52) U.S. Cl. 290/1 A; 123/3; 705/14.11; 903/909; 415/916

(57) ABSTRACT

A system for generating energy using the rotating wheels of a vehicle and for collecting such energy is provided. An alternative system for powering vehicle engines using relatively inexpensive fuel sources is also provided.

### CROSS REFERENCE TO RELATED APPLICATION(S)

This application is a continuation-in-part of U.S. patent application Ser. No. 12/428,629, filed Apr. 23, 2009, entitled “ALTERNATIVE ENERGY GENERATION SYSTEMS FOR VEHICLES.”

### BACKGROUND

1. Field of the Invention

The present invention relates to a system for generating energy and a system for collecting and distributing the generated energy. The energy generating system may be incorporated into any suitable vehicle such as cars and trucks and utilized also for non-vehicle usages.

2. Prior Art

Current U.S. energy consumption is some 100 billion BTU a year and anticipated to climb to 130 quadrillion BTU in 2030. Alternative energy sources are being sought and environmentally responsible energy solutions are being considered.

### SUMMARY OF THE INVENTION

The energy generation systems described in this disclosure are environmentally responsible solutions that may not require additional natural resources and may not require the development of new technologies.

In accordance with the instant disclosure, there is described a system for generating energy using the rotating axle and wheels of a vehicle and for collecting and distributing such energy.

In accordance with the instant disclosure, there is described an alternative system to power vehicle engines using relatively inexpensive fuel sources.

In accordance with the instant disclosure, there is described an alternative system to power vehicle engines using magnetic and electromagnetic forces by at least one of a polarity utilization and induction.

Other details of the energy generation systems of the present invention, as well as other objects and advantages attendant thereto are set forth in the following detailed description and the accompanying drawings, where like reference numerals depict like elements.

### BRIEF DESCRIPTION OF THE DRAWING(S)

FIG. 1 illustrates generation of energy from spinning axle/wheels of a moving vehicle.

FIG. 2 illustrates an alternative energy generation system for use with a vehicle.

FIG. 3A is a cross-section of a cylinder in a vehicle engine.

FIG. 3B illustrates the formation of acetylene inside a cylinder chamber.

FIG. 4 illustrates an aggregator and battery bank.

FIG. 5 illustrates an embedded generator cart (EGC).

FIG. 6 illustrates multiple generators and secondary gears.

FIG. 7 illustrates an introduction to the two-stroke superconductivity energy generation.

FIG. 8 illustrates an actual two-stroke superconductivity energy generation.

FIG. 9 is a schematic illustration of the axle generation of energy in a vehicle.

FIG. 10 is a schematic illustration of piezoelectric energy generation in a vehicle.

FIG. 11 is a schematic illustration of a process for generating energy for elevators.

FIG. 12 illustrates an IRVS principle.

FIGS. 13(a) and 13(b) illustrate the options for an axle generator.

### DETAILED DESCRIPTION OF THE PREFERRED EMBODIMENT(S)

Vehicles consume fuel energy. Some newer vehicles are operated by electrical energy and other fuels, such as alcohol mix, are making their way into the marketplace. Irrespective of the energy source for vehicles, the vehicles themselves could be the generators of energy. For example, energy could be generated from the power of braking a speeding vehicle or from vehicle shock absorbers. Another source of energy relates to rotating parts of a vehicle, such as the axle or wheels of the vehicle.

Mechanical energy can be converted to electrical energy. For example, when an armature conductor having an iron core and carrying conductors on its surface revolves in a magnetic field, the conductors on it cut through the magnetic flux causing the induction of electromagnetic force in each of the conductors. The revolution could be either by the armature within a fixed magnetic field or a revolving magnet around a stationary armature. Either way, an electromagnetic force is generated.

In accordance with the present invention, the amount of electromagnetic energy produced for a given magnetic field can specifically be determined according to the parameters of the revolutions, conductors, and magnetic flux. Using this information, an electric generator utilizing the rotation of the axle/wheels in a vehicle can be constructed. One embodiment could be to contain the appropriate amount of electrical energy of permanent magnets and rotating core of conductors. Each rotating wheel on the vehicle can be provided with the core and conductors and a stationary permanent magnet could be located in proximity to the rotating conductors of each wheel of the vehicle, such that the conductors would cut the magnetic flux of the magnet upon the rotation of the wheel. Alternatively, one could construct a similar resulting energy generation system where the permanent magnets are attached to each of the rotating wheels and a stationary part, such as a back plate, is equipped with a core with one or more conductors. An exclusion should be noted, wherein the instant disclosure is not for energy created by the rotation of the wheels to move the car that in turn will cause rotation of the wheels. Rather, the car is propelled by other sources of energy that could be augmented by the electromotive force from the wheels. The resulting current could either be utilized as alternating current or be turned into direct current by using an AC to DC converter.

In a certain embodiment, both DC and AC can be utilized in a current-hybrid vehicle. In such an embodiment The AC generated from the rotating wheel or axle can be used to propel, in part, the vehicle when utilized in the same way as an electric vehicle uses the DC from the battery pack, except that there is no need for a battery pack for the duration of the AC from the wheels, nor a DC controller to convert it into an AC to send to the motor. The AC is readily available as output from the electromagnetic force generated by the wheels equipped with the system of magnets and conductors, as described in this instant disclosure. The AC is sent to the motor and in part can also be used as a recharging system for any DC batteries in the vehicle. Therefore, in a certain embodiment, a vehicle can operate on the AC current from the wheels augmented by a DC battery to enable a self-sustained (current-hybrid of both AC and DC) driving vehicle.

In certain embodiments it is possible to separate between the energy produced by individual rotating wheels as described above and utilize each wheel for a specific operation or combined operation with anther wheel(s) energy production. Thus, some wheels can propel for example the car using AC, another for a DC battery controller, yet another when needing to charge batteries, etc.

Further, the energy resulting from the generated current could be stored in an appropriate collection device on the vehicle, such as capacitors or flywheels for later discharge to a collection system as discussed below.

Energy generated by vehicles in such manner could be used beyond or in addition to the needed consumption of a moving vehicle, noting the above exclusion of perpetuum mobile. Such energy could be collected by a general energy collection system and made available for general consumption. The owners of each vehicle could be reimbursed for generating power and contributing it to the general energy collection system. The economy of scale would result in significant additional energy added to the national consumption, for example, by uploading it to a national grid. 10% of the national energy needs could be supplied by the system of the present invention.

The general energy collection system may comprise energy collection depots in private as well as public areas or facilities, such as power supply stations for vehicles or parking areas, enabling the transfer of energy from vehicles while the vehicles are not in motion. Places, such as gasoline stations, electric supply stations, battery swapping stations, parking buildings, shopping plaza parking lots, highway food locations, parking meters on the street that are properly equipped for such energy collection and homes could be energy collection depots. The energy collectors may be simple energy receiving devices that accept energy and register amounts received with the identification of the contributing party. Energy depositing vehicles could either be rewarded with on-the-spot vouchers towards payments or for discounts in a shopping area comprising collectors or be credited for proper reimbursement. The vehicles may be equipped with a counterpart section enabling the delivery of the stored energy and accounting for the reciprocal appropriate bookkeeping. The outlet for receiving energy may be designated with a symbol, certain color(s) or both, identifying it to the public as suitable for uploading of energy.

Vehicles may be equipped with any internal facility known in the art for enabling replenishing of energy and thereby enabling further mobility. The internal facility may in one embodiment of the present invention further contain at least one of an active and a passive sub internal facility to enable access to the external energy providing facility. The passive internal sub facility may be a release procedure for an article needing replacement, such as a battery or a tank holding specific substance in the form of such as a solid, liquid, gas or a combination of at least two of them that needs replacement. The active internal sub facility may be an interface to the external facility providing energy to the vehicle, such as a cap for opening a tank for a gasoline nozzle or an electrical chord and plug for receiving electrical energy.

The at least one of the passive sub internal facility and active sub internal facility may in one embodiment further be affected by a device enabling at least one of their activation and utilization for replenishing energy from the external source. The device may be engineered to enable the functioning of the at least one of the passive sub internal facility and active sub internal facility only upon the occurrence of at least one of the initiation and completion of uploading electrical energy generated by the at least one of the rotating axle and wheels of the vehicle or its auxiliary to a receiving facility that is external to the vehicle.

Some of the embodiments may contain the ability to provide energy replenishment to the vehicle in somewhat simultaneous fashion to the uploading of electrical energy from the vehicle. For example, when an electric vehicle needs additional charging performed by hooking up a cable between the vehicle and the energy providing facility, such cable may contain a secondary cable dedicated to the upload function that contains an additional and embedded prongs in the plug used to replenish energy to the vehicle so that while energy is flowing to the vehicle on one cable, the other cable enables uploading energy from the vehicle. Such a plug could have for example, two longer prongs closer to its circumference and two shorter prongs closer to its center, constructed in such a safety oriented fashion that no contact could ever be made between unrelated prongs.

Uploading energy to any entity that is at least one of a private entity, public entity or contributor to the national grid may be done in any form known in the art. Further, a Green Electrical Socket may be constructed to contain at least one of a regular energy outlet socket and an energy-receiving socket. The Green Electrical Socket may also be fitted with the hardware and software required to receive and transmit information related to the party contributing energy that is uploaded through the Green Energy Socket. Such information may be transmitted in wireless form or by wire and may utilize at least one of the cables connected to the Green Electrical Socket for such transmission. Further, the Green Energy Socket may be any of the traditional plug and wire accepting unit or a wireless accepting unit for at least one of the data information and energy. Green Electrical Sockets may be identified by a specific form, shape, symbol or character(s) and may carry specific color(s).

Energy collected in the aforementioned depots can either be directed for immediate usage such as in the national grid or be stored for later usage. Such storage as well as storage in the vehicle before it can be discharged to a collector can be achieved in various means. The current produced by the rotating axle/wheels of the vehicle can be stored in such facilities as DC batteries after it had been converted from AC current, can be stored in capacitors or can be stored in flywheels. Such storage forms are known in the art and can easily be calculated for capacity and installed in vehicles, as well as collector facilities.

Further, vehicles may be equipped with the ability to move energy from one form of internal vehicle storage to another form of internal vehicle storage in anticipation of discharging the energy and preparing its discharge in the most efficient and timely fashion or for any other reason. The vehicle may also have the hardware and software necessary to determine how imminent energy discharge is foreseeable, such as by monitoring energy left in the vehicle to enable motion and/or utilizing state of the art technology, such as GPS to realize the proximity of energy replenishment stations to activate energy transfer among internal holding facilities for an efficient discharge. The vehicle may also respond to such energy discharge preparations according to mechanical signal activated by the driver or voice indication from a driver announcing such information as parking or refueling.

Generating energy without the direct taxation of an energy source is not limited to generating energy from rotating axles or moving vehicle wheels. Another example is solar energy obtained from collectors positioned in such locations as roofs exposed to sunrays or installation of constructed collector fields utilizing wind power. A program that will facilitate energy contribution from the aforementioned energy sources can be termed a subsidized generator system (SGS). Under one SGS program, the energy generating hardware may be installed at no cost to the customer akin to free installation of a product but collecting fees from the customer thereafter such as in the Direct TV business model where the equipment is provided free of charge to new subscribing customers. The difference in said SGS program is that such customers pay negative fees thereafter. Namely, instead of paying monthly fees, the customers receive monthly payments from an operating business facility. The amount of such fees can be determined in a properly calculated business model and under one scenario in a similar way to paying a mortgage where the interest is paid first and as time progresses the principal of the loan becomes gradually smaller, in such scenario the payout to the customer would be increasing in time. The energy program described herein will operate in the negative system where, when the profitable energy contribution will exceed the amounts of hardware cost, installation and maintenance, the energy contributing party will be reimbursed accordingly. The operating facility will on the other hand have a profit from the residual amounts left after fees paid to the contributing customer whereby a system of maximizing profit for both contributing customer and operating facility takes effect with time.

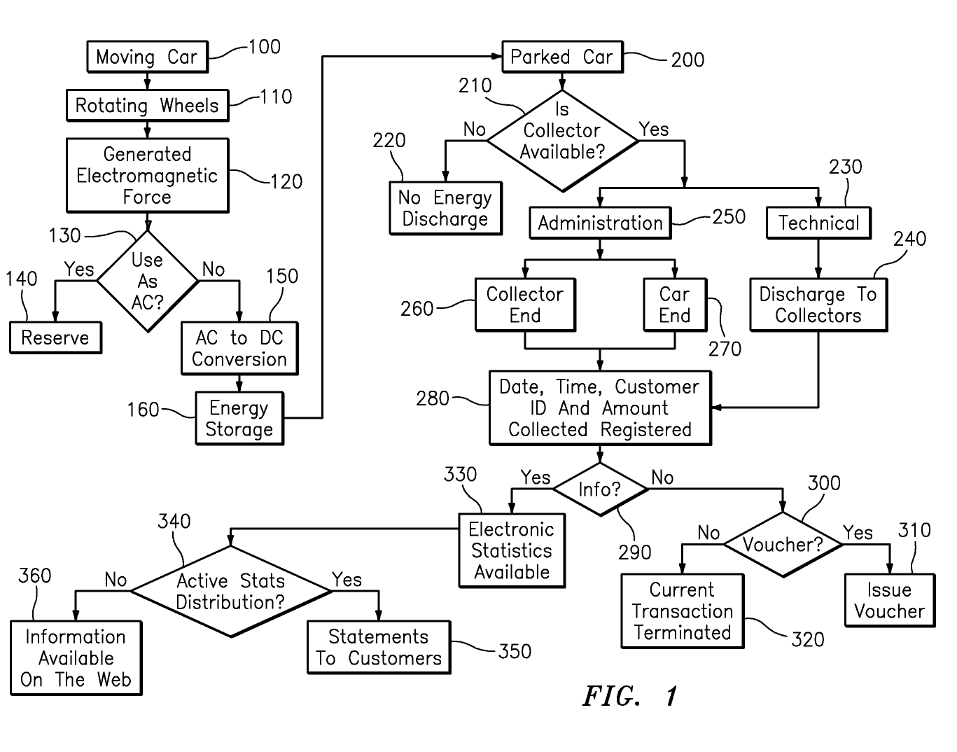

Referring now to FIG. 1, a moving vehicle shown in step 100 has its wheels rotate in step 110 generating electromagnetic force in the form of current in step 120. In step 130, it is determined if the energy generated as alternate current (AC) is to be used rather than converted to direct current (DC). If affirmative, the current undergoes certain procedures in step 140. Otherwise, the energy undergoes AC to DC conversion in step 150 using any suitable AC/DC converter known in the art and is stored in step 160 in any suitable storage device known in the art. When the vehicle is parked as in step 200, it is queried in step 210 whether a collector is available. If it is determined that no collector is available, then no energy is discharged in step 220. Otherwise an administrative function starts in step 250 and the technical segment starts in step 230, where the discharge from the vehicle to the collector facility 240 and related information is provided to the administrative segment 280. The administrative function in step 250 monitors the end of delivery for the vehicle in step 270 and the end of the collection by the collector in step 260. Data such as date, time, location ID, customer identification and amount delivered and collected is verified and appropriate ticket or receipt may be provided in step 280. Such receipt may note information such as the date, time, location ID, collector ID, discharging customer ID and the discharged amount from collector 240 and collected amount of energy from step 260. In step 290, the vehicle and/or its operator is queried if information from step 280 is desired. If the answer is negative, then the vehicle and/or its operator is queried in step 300 if a voucher is desired. If affirmative, then a voucher is produced in step 310 using any suitable printing device known in the art, otherwise the transaction terminates in step 320. If the answer to the query in step 290 is affirmative, then electronic information is available in step 330, such as on the designated web site and it is queried in step 340 if active distribution of such electronic information is desired. If the answer is affirmative then in step 350 the information about the individual transaction may be included in the general periodic statement to the customer. Otherwise the information may be available in step 360 on the designated web site to the customer having suitable identification.

An alternative design for energy obtained from revolutions of wheels or their cause provides for additional innovative technology as described below.

The generation of energy by spinning wheels with conductors and magnets where one is stationary and the other rotating is not just limited to vehicles. For example, gym areas contain treadmills, as well as exercise bicycles. Considering exercise bicycles for example, the user causes rotation of the wheels during exercise by expending personal energy, resulting in electrical energy generation through an arrangement of magnet(s) and conductor(s) attached to the bicycles. The generated energy could then either be utilized locally at the gym for local needs or transferred to the national grid, such as in the forms already discussed. The latter case would benefit the nation by reducing polluting energy generation, as well as allowing the gym business to earn money from selling its excess electrical capacity. Single and two-wheel apparatus, such as vehicles can also be manifested in other forms, such as bicycles and motorcycles with two wheels or the Sagway containing a single axle and wheel, all of which may be equipped appropriately for generation of electricity as described in this disclosure.

Returning now to vehicles, we consider the rotational energy. In U.S. Pat. No. 723,727 by Philip Pfeil, an external dynamo is introduced. In U.S. Pat. No. 5,215,156 by Stulbach et. al., the shaft of an electric generator is linked by a mechanical amplifier to a rotating axle. However, such concepts introduce an intermediate level between the rotational parts of a vehicle and a generator that by the physics of the second law of thermodynamics would reduce the efficiency of the operating construct. To this end, an improvement is introduced, whereby such energy loss is eliminated at the point of contact and the production of electrical energy is more efficient. Accordingly, there is described the turning of the rotating wheel(s) and/or axle(s) of a vehicle into an electrical generator during movement of the vehicle by equipping them with magnets and conductors, where one of them is subject to rotation while the other remains stationary.

As is well known, a reciprocal positioning of magnets and electrically conducting wires gives rise to electricity flowing in the conductors upon motion of either the conductors or the magnets. This principle is utilized to generate electricity flowing in a moving vehicle by turning its rotating wheels into electrical generators. In one such embodiment, at least one magnet is part of the rotating axis as it is affixed to or is part of the end part of the rotating axle shaft, while the conductors are wires in a fixed non-movable coil form, in close proximity to the rotating magnet(s), so they could cut through the magnetic field. Such conductors may be part of or affixed to the backing plate or reside in a specially constructed fixed housing surrounding the rotating magnet(s). The electrical power generated in the conductors during motion of the vehicle is then available for extraction.

While each of the wheels of a vehicle could in one embodiment be provided with moveable magnet(s) in proximity to non-movable conductors to produce electricity upon motion of the vehicle, the axle shaft itself provides ample space for becoming part of a functionally equivalent generator of electricity in the following embodiment. One can position magnets at three areas along the axle, where each magnet is mounted on the axle shaft at a particular location that is separated from any other similar magnet. Since the end result is generation of electricity, one can create a multiple generator situation, such as a triplicate situation with three magnets, since only one third of each of the generated energy related to any one such rotating magnet results in usable energy. One could place as many magnets as desired, including one large magnet covering the whole axle and a parallel length of armature with conductors or a group of conductors separated and spaced from each other. However, the present embodiment calls for individual multiple such magnets. Each of the multiple said magnets affixed to the axle or built as part of it, is in close proximity to a specific corresponding coil of conducting wires that would cut across the magnetic field of the rotating magnets during revolutions of the axle. The end points of each said coil of conducting wires are the electricity providing points from where the resulting energy may be collected upon the motion of the vehicle. It should be noted that instead of rotating magnets one could position conducting coils on the axle and have the magnet(s) in a fixed location close to the rotating axle. However, such a reversal of roles, while correct by the laws of physics, presents an engineering problem for collecting the generated electricity from a rotating conductor coil.

The faster the axle/wheels spin the more electrical energy is generated. However the speed of a vehicle depends on the driven area, such as when the speed is slower in urban areas. Specifically for such cases, the rotations generating electricity may be increased, however, without increasing the rotational speed of the vehicle's wheels.

This may be done by having a secondary wheel, smaller in diameter than the vehicle's wheels, being spun with the vehicle's wheels, thereby making more rounds per each round that the vehicle's rotating wheels that come in contact with the road. The same procedure applies also in the case of the rotating axle when appropriate. The inefficiency introduced by the added contact is accounted for by reducing further a certain percentage from the diameter of the introduced wheel, thereby adding to the increased speed. It is shown below how such contact at 90 degrees is achieved. The vehicle can be further equipped with multiple such smaller spinning wheels, either one per each vehicle's wheel or have a device where multiple smaller rotating wheels will generate the energy as they will each be equipped with magnets and conductors, wherein one of the latter (magnets or conductors) will be rotating and the other one stationary in accordance with the laws of physics.

The rotating wheels of the vehicle, i.e., those normally having tires on them and making traction during the vehicle's motion may be defined as the Primary Wheels (or Primary Gears). Primary Wheels will also be so defined for any primary rotation-causing wheel or gear, such as a threaded axle encountered below. The Secondary Wheel (or Secondary Gear) may be defined as any wheel or gear whose rotation is activated and maintained by a Primary Wheel and that in turn provides the rotation or torque to the electricity-producing generator.

In one embodiment, there is mounted on each of the vehicle's wheels a serrated wheel with a radius comparable to the size of the wheel and have its teeth come in contact with the teeth of a much smaller serrated wheel causing the smaller wheel to move at a faster velocity than the larger wheel. Utilizing our definition, the secondary wheel is of a smaller diameter compared to the primary wheel. In other words, the diameter of the primary gears being different causes a faster rotational velocity to the smaller secondary wheel. Such a differential size arrangement is similar to spur gears in the gearbox of vehicles, but for practical reasons might be built as helical transmissions reducing noise made on contact or bevel type allowing also a 90 degree angle between the two.

There can be positioned four (4) smaller secondary gears to any primary gear of a vehicle's wheel, where each one of them activates a generator upon the rotation of the vehicle's wheels during motion. In a 4-wheel vehicle where each wheel is so equipped with four electrical generating contraptions one ends up with 16 generators where the energy is generated while the car is moving.

Further, such structure can be cascaded to increase the number of rotating electrical generators. For example, in one embodiment any one of the rotating electrical generators can also be connected to additional, smaller rotating electrical generator, such as in beveled wheels and if any such second level generator also activates a third level of 2 to 3 such generators, then the vehicle will have at its disposal 32 to 48 generators where the second tier is rotating at a speed faster than the wheels of the vehicle and the third tier, being smaller than the second tier even faster. Thus the amount of the energy generated can be multiplied significantly, even after reduction due to negative efficiencies resulting from the second law of thermodynamics and the subtraction of added weight to the car from the power generating units, resulting in a significant gain in the production of electrical current.

Due to the ability to change speed of revolutions, as well as angles of engagement, it is possible to maneuver the desired rotational energy to a set of serrated wheels operating the magnets and conductors away from the invocating wheels that come in contact with the road. In one such embodiment all the rotating end-wheels generating electricity can be collocated in one area, either on a platform, in a column or inside a safeguarding box to mention some possibilities.

The term “axle” is defined in its customary meaning of a transverse bar or shaft connecting the opposite wheels of a vehicle. One can also refer to axle when the two wheels, at each end of the axle are operating independently of each other and are not connected. The definition of the wheels of the car touching the road as the primary wheels, or call such wheels the primary gears in conformity with the vocabulary used for vehicles is maintained. Likewise the wheels connected to the primary wheels (or their (primary) axle), such as by contact of the teeth of both wheels (or contact of secondary wheel with a threaded (worm) gear of the axle) will be defined as secondary wheels, or referred to as secondary gears.

If one takes a gear ratio of 2:1 where the diameter of the secondary gear is half of the primary gear, the secondary gear will rotate at twice the speed of the primary gear. Accordingly, the number of teeth in the primary gear will be twice as many as in the secondary gear and if one wants the secondary gear to rotate three time as fast as the primary gear then its diameter will be ⅓ of the primary gear and the number of teeth in the secondary gear will be ⅓ of the number of teeth in the primary gear. It should be noted that albeit the physics governing such ratio of speed, engineering of the gears could control the ratio of rotational speed even if there is slight imperfection in the ratio of the diameters. One can further induce a faster rotational movement in secondary gears utilizing the train gear engineering principles where the secondary smaller gear is attached to a larger gear that in turn causes another (tertiary) smaller gear to rotate in a now faster rotational velocity than the secondary gear. If one keeps the ratio of 2:1 then the tertiary gear will rotate twice as fast as the secondary gear and four times as fast as the primary gear. Obviously with a larger diameter ratio than 2:1, higher final rotational speeds will be realized. Such train gear construction can bring about fast rotation, increased electrical current generation for the vehicle and also output for other usages. Finally, considerations for fast rotation and limited space in a vehicle could benefit from the usage of what is commonly referred to as a Worm Gear, where the teeth of a gear receive their rotational energy from contact with a threaded shaft. Since, weight is also very important in utilizing the technology of the instant disclosure for creation of electrical energy in vehicles, it is worth while mentioning that one could utilize chains or tooth belts to activate multiple generators, and if desired also away from the primary wheel (gear) creating the motion for the secondary, tertiary, wheels (gears), etc. The physics and engineering elements described herein can be utilized in constructing various embodiments of the Wheel Charger in accordance with the instant disclosure.

What is defined as Wheel Charger may not be the vehicle wheel at all, but rather the axle that rotates and in turn causes the two wheels connected to it to rotate. Such axle can be either all made as a worm gear or selectively so machined where certain selected segments of it can be machined to be threaded that will cause rotations in gears with teeth connected to it. It will also enable disengagement for one or more of the selected gears from the threaded axle when appropriate. Further, a procedure may be utilized with selective activation of any one or more of the secondary gears bringing it into contact with the primary gear, or alternatively moving an armature with conductors into or away from the proximity of any specific magnetic field generated by rotation to increase or decrease electrical production. In the latter case one may construct a Generators Shift Box, that akin to a conventional gear box in a combustion engine vehicle allowing to control power and speed of a vehicle, the Generators Shift Box allows functional equivalent activities by activating or shutting off additional electromagnetic generation through selective movement of armatures with conductors into and out off the rotating magnetic field. In one embodiment related to worm gears there are four worm gear segments (i.e., threaded segments of the axle) to each axle connecting the wheels of a vehicle, thereby creating eight engagement points for secondary gears in a four-wheel vehicle. It should be noted that the front wheels of a back-wheel drive or the back wheels of a front-wheel drive are not connected to each other and with lack of differential gearbox the worm gears of their axles would be independent of the other. The secondary gears connected (when engaged) to such axles, either propel the generators or are a conduit, such as with beveled gears, to the electric generators that can be concentrated in a dedicated area of the vehicle. It should be noted that the electric power generators might rotate at different speeds since those on one side of the differential gearbox in a vehicle might operate at a different speed than the ones on the other side of the differential gearbox due to the differential compensations, such as when the vehicle makes a turn.

Yet in another embodiment there exists a device on wheels connected to the rear of the vehicle, constituting electrical generator facility for the vehicle. The device generates energy based on the rotation of its own axle(s) and/or wheels. Such a device would have two or more wheels and its movements would be coordinated with that of the parent vehicle.

In one embodiment, the electric generators are located either in the immediate vicinity of the axles driving the wheels, such as in a dedicated area along the axle and parallel to it forming with the axle or without it the electric generation, or dispersed due to weight-load consideration in designated locations of the vehicle and activated utilizing such means as chains mentioned above.

Another embodiment takes into consideration the added energy required, in order to cause mobility to the vehicle that has generators with magnets that add to the weight of the vehicle and thereby increase the energy consumption, as well as any efficiency losses due to the introduction of contact points between gears. Therefore, in this embodiment the generators with magnets have their own separate housing enclosure that does not add to the weight of the vehicle during its mobility. Such separate housing enclosure could tag behind the vehicle or operate underneath the body of the vehicle. The separate housing enclosure is fitted with its own set of wheels (having smaller diameter than those of the vehicle) enabling it both to make independent contact with the road, as well as generate the mechanical rotation needed for the electrical generators within the enclosure that we will refer to as the “Embedded Generator Cart” (EGC).

The wheels in the EGC are made to be independent of each other so that no differential gears will be needed to compensate when the vehicle and thereby the EGC make a turn. The driver may have the ability to activate or disengage at will any of the independent generators in the EGC.

Each axle in the EGC can have threaded segments that could deliver rotation to secondary wheels (gears) that in turn propel the rotating part of the generators. The amount of energy delivered by the EGC can vary if one enables control of what generators would be engaging the worm gear of the axle. For example, if one allows all generators equal engagement and the EGC has four wheels with two axles, where each of the axles can engage four generators, then one has an 8-generator EGC. Adding two more axles resulting in a 4-axle EGC, allows for 16 generators delivering electrical energy. This embodiment could also have the option of housing at least one battery on the EGC in order to reduce the weight on the vehicle and free more usable space in it. In one embodiment at least one of the axles in the EGC is either a magnet itself or has magnet(s) affixed to it, thereby providing the rotating magnetic field without the need for secondary wheels and has in its proximity armature(s) with conductors.

The EGC can also carry on it at least one battery and preferably the whole battery bank in order to reduce any weight on the vehicle proper. The only energy consumption burden on the vehicle of the EGC will be its lowering to the ground when traveling and lifting it back into its housing location (within or without the main vehicle body) and the energy expensed in ascertaining it moves contemporaneously and in tandem with the vehicle.

Thus, various mechanical engineering aspects, as well as some energy consumption evaluation need to be taken into consideration in this embodiment, such as the following:

(1) The lowering of the EGC to the road and lifting it back to its resting position;

(2) The connectivity arrangement between the EGC and the vehicle proper, so that no friction or runaway EGC situations will arise during vehicle motion:

(3) Acceleration, deceleration and braking of the vehicle will exert momentum to the EGC that needs to be accounted for, as well as braking facility if any for the EGC;

(4) The conduit of electrical energy from the generators on the EGC needs to be coordinated and controlled, as well as the input into the battery or batteries;

(5) The aerodynamics to minimize air friction, whether the vehicle operates with an EGC or has another embodiment of the invention; and

(6) Metallurgical integrity observed when machining the threaded sections in the axles.

The Battery Bank

The battery bank will house at least one battery and preferably multiple batteries enabling recharge of one while the other provides energy, for such purposes as supply to outside facility or to propel the vehicle. In one embodiment the vehicle will operate by a particular battery (battery “n”) until it needs replenishing of energy. Any energy if directed at restoration of battery energy by such mechanism as braking the car or through electrical generator functions as described in this disclosure, will be directed to the then battery “n” that dissipated all or nearly all of its energy for mobilizing the vehicle or to an external receiving facility. During the recharge of battery “n”, the level of available energy in battery “n” is monitored. That is, the battery voltage is monitored, as well as the current flow and the battery temperature. When the battery temperature seem to rise beyond a predetermined level, the charging is temporarily suspended and is directed to the next battery in line waiting to be charged and then reverts back to charge the battery left after it cooled off to a prescribed level. Monitoring is also applied to battery engaged in delivering energy to the engine. When the monitoring shows the battery, say “n” has reached the predetermined level of declared depletion (preferably somewhat above the real depletion state), the battery is disconnected from further supplying any energy to the engine and is replaced by the full capacity battery “n+1” that is in turn will now be supplying energy to the engine. The declared energy depleted battery “n” is now connected to the energy source coming from the generators that in turn is rotating due to the rotations of the wheels and joins any other battery, if applicable, being recharged in the queue. Battery “n” is being monitored while being charged in the same way the monitoring was discussed above. When battery “n” is declared fully charged, it becomes one of the charged batteries in the battery bank and receives an appropriate serial order to keep the charged batteries in a FIFO (First In First Out) order and ready to supply energy to the vehicle when its turn arrives.

It goes without saying that the batteries as well as the generators are well protected for inclement weather and water to safeguard the batteries as well as the passengers.

Cyclical Recharge of Battery Packs.

In one embodiment, the vehicle in motion consumes energy from a battery and the invention described herein also allows for a system where energy is dissipated from a particular battery and upon depletion of the energy content moves to a next battery in line. Further, once the energy from that battery has been depleted as well, the energy consumption for the vehicle moves to the next battery in line. This will ascertain that when a battery gets depleted of energy, the vehicle continues to advance getting its energy from the succeeding battery while the one with the depleted energy moves into the cycle of replenishing it by directing to it electricity from such source as the wheel generators. Once it has been recharged, it gets back in line for use.

The storage to and discharge from a battery bank as disclosed herein is equally applicable for a bank of at least one flywheel that may store energy and discharge it either to an outside receiving collector, such as contribution for or sale to the national grid, or utilized for internal consumption of the vehicle, such as propelling the vehicle for motion or recharging DC batteries. Such a bank of at least one flywheel may be composed of at least one of an AC flywheel and a DC flywheel.

The Noise Factor and its Elimination

The rotating generators and the secondary gears making contacts with the primary gears will produce noise. There are various ways to muffle the noise that can be constructed. However, there may be an additional device to block the noise. The device is good for blocking any form of noise, such as blocking the noise of a snoring spouse from disturbing the other spouse lying in bed next to the snoring person.

The preferred embodiment of the noise management system (NMS) device is based on the laws of physics, where sound traveling at some 0.33 km/Sec is much slower than light traveling at a speed of 300,000 km/Sec. Further, sound can be converted to electrical energy and electrical energy can be turned into sound. The NMS utilizes these physics laws to block noise as follows:

The device contains a diaphragm that is installed at one edge of the chamber where noise is produced. The diaphragm vibrates with the noise waves converting it to electrical energy, such as is the case of a telephone receiver. The electrical energy then moves (much faster) to another segment of the device that converts it back to sound energy, however in a different phase that is the exact opposite of the recorded noise. For example, if the incoming noise were to be recorded as a sinusoidal wave, the emitted sound after conversion from the transmitted electrical energy would be a cosine wave. The opposite phase will cause cancellation of the original sound amplitude resulting in the elimination of the noise.

Utilizing the Generated AC

The AC generated from the rotating wheel can be used to propel, in part, the vehicle when utilized in the same way an electric vehicle uses the DC from the battery pack, except that there is no need for a battery pack for the duration of the direct AC supply from the wheels, nor a DC controller to convert it into a DC to send to the motor. The AC is readily available as output from the electromagnetic force generated by the wheels equipped with the contraption of magnets and conductors, as described in the instant disclosure. The AC is sent to the motor and in part can also be used as a recharging system for any DC batteries in the vehicle. Therefore, in a certain embodiment, a vehicle can operate on the AC current from the wheels turned generators) augmented by a DC battery to enable a self-sustained (current hybrid of both AC and DC) driving vehicle.

Further, in an AC embodiment one would have the following benefits:

An AC motor receiving current directly from the generation by wheel motion

When utilizing AC motors with a regen feature (i.e., during braking the motor turns into a generator and delivers power back to the batteries) the DC batteries in the vehicle get recharged during braking time

Ability to utilize a variety of available industrial motors and thereby supporting the national economy.

Environmental Protective Embodiment

The environmental protective embodiment takes into account primarily social and planetary responsibility considerations and as such is governed by the following requirements:

The embodiment should be as environmentally friendly as possible;

Fast time to market in order to curb unfavorable emissions to the atmosphere at the earliest time;

As a corollary rely as much as possible on existing components in the market that will save time to design and test new components; and

Reliance on existing components will help the economy by new orders to existing products.

Governed by such considerations, the environmental protective embodiment is an electric three phase AC motor car, powered by energy provided on the fly by the current generated from the rotations of primary and secondary wheels and augmented by battery energy from a battery bank that is recharged while the vehicle is in motion and augmented by external source when needed. Such battery bank benefits from unutilized energy (i.e., excess energy) provided the engine by the generators or by additional generators powered by wheels, as well as tapping into other sources of energy for the battery bank, such as energy obtained from applying the brakes to the vehicle. Charging from an outside source, such as an electrical socket, such as at home or a charging depot will occasionally complete the needed charge to be an almost self-sufficient electric vehicle. Excess energy can also be sent back to the national grid as had already been disclosed before. The process is summarized in drawing number 6.

The Aggregator

The aggregator role is to accept energy from at least one generator and synchronize the input when more than one generator is delivering energy to it. Combining the energy from multiple generator sources that provide them, as Alternating Current (AC) requires precision of phase alignment when their outputs are connected in parallel even if they start running at exactly the same frequency and voltage. For example, if their phases are shifted by 180 degrees, the generated current will flow only between the generators resulting in badly damaging them. The aggregator contains the necessary elements for providing synchronicity by controlling the phase of at least one of the contributing generators and guarantying phase alignment that is vital to the integrity of the energy aggregation. The necessary elements that will guarantee a combined output from the at least one generator available for the electric motor in the vehicle, with satisfactory aggregator integrity can be constructed in any suitable manner.

Utilizing Alternators

It should be mentioned that the present invention is not a variation of an alternator, nor is it possible to extend an alternator design to arrive at the technology described herein, as will be realized shortly. To begin with, alternators are powered from the revolution of the crankshaft in a vehicle, which in turn is rotating by the strokes provided in succession by the pistons of one cylinder after another, resulting from their undergoing explosions of the inner combustion process in each one of them. When a car is powered by an electric motor, there is no need for a combustion engine and therefore the energizing mechanism for the alternator disappears, though electricity is now available from other sources, being that the car has an electric motor.

Utilizing Chain Gears

Chain gears are secondary gears where the chains start from the primary wheels (or their axles) and hinge at the other end on either a secondary wheel or the axle at the other end of the vehicle with the secondary gear being somewhere in between. In actuality there could be more than a single secondary wheel in between, each activating a designated electricity generating apparatus.

Yet another technique for providing energy for vehicles can start from the following assumption. The materials to be used should be in abundance, preferably regardless of the geographic location. Two such materials can be water and air. Water can be a powerful contributor in generating energy. If one considers an internal combustion engine, the pistons are pushed up or down in the cylinders' chamber due to the explosion occurring in the cylinders' chamber. In each such explosion, there is either a shock wave or rapid expansion of compressed air that moves the piston. Thus, in trying to duplicate explosion, one can advance the idea that water can be the appropriate media. For example, it is known in chemistry that water should not be poured on concentrated (i.e. 6 normal) sulfuric acid because an explosion could occur, but pouring concentrated sulfuric acid on water would not cause such explosion. Thus, a simple mechanism for creating explosions is the spraying of concentrated sulfuric acid with water. Another example is the immersion of calcium carbide (CaC₂) in water or in one embodiment water can be sprayed into the cylinder forming a mist into which carbide can be injected, such as in pellets, small granules or dust, which reacts and gives acetylene (CaC2+H2O-----→H—C= C—H), where CaC2 is obtained in an inexpensive industrial process (and there is a notable three valence connections between the two carbons). The process could be used for the purpose described above. Thus, all the raw materials needed here are inexpensive and are calcium carbide and water to generate the propulsion and water, coal, and limestone to create the calcium carbide; (calcium oxide+coke at 2000 degrees Fahrenheit yields CaC₂), where the Calcium Oxide is created by thermal decomposition of limestone. Water is plentiful, coal is in abundance (demonstrated coal reserves in the US are close to 500 billion short tons) and so is limestone (a geologist estimated that there are some four (4) billion tons of recoverable limestone in the 85,000 acres located in Pocahontas and Greenbrier counties in southeastern West Virginia alone.

The formed acetylene gas is sensitive to variety of conditions that can bring about its explosion causing the piston movement in the cylinder's chamber, such as excess pressure, excess temperature, static electricity, or mechanical shock. Any one of such conditions can bring about the desired explosion that can also occur spontaneously without a triggering agent due to the unstable nature of acetylene.

It should be noted that acetylene gas is normally stored in cylinders and a distinction needs to be made that the cylinders discussed in this instant disclosure are called cylinders but are NOT such storage cylinders but rather the cylinders in the engine of a vehicle that contain the pistons involved in the movement of the vehicle. Further, care is needed in building the vehicle's engine based on this instant disclosure to ascertain that no unintended portion of the acetylene propagates back into the vacant space of the chamber of the cylinder after the piston has been propelled by the explosion so that no undesired explosion, that is not related to the movement of the piston would occur.

Likewise, temperature and cooling measures may be needed to ascertain that heat generated by such aspects as the friction of the moving piston or the explosion does not trigger any premature follow up explosion for the next batch of acetylene formed in the process of calcium carbide and water, since acetylene can undergo an explosive decomposition reaction, even at Normal concentrations (i.e. of 100%).

However, the fact that acetylene is prone to explosion in presence of heat can be utilized to maximize the efficiency of acetylene generated by carbide coming in contact with water. In such an embodiment instead of cooling measures introduced as previously discussed, the heat generated in any previous explosion of an acetylene quantity could be taken into account so that for example, less acetylene will be needed for a subsequent explosion. Pre-calculation of heat to carbide quantity ratios as well as proper heat sensors employed, such as in the cylinder together with gauges allowing the proper reduced amounts of carbide to be released to the water from the carbide holding tank will enhance the efficiency of the acetylene engine and reduce the amount of carbide needed to be carried by the vehicle.

Further, the location of acetylene generation for the engine can be at any suitable location and not necessarily in the cylinders themselves. The interaction of water and calcium carbide can take place, as mentioned, in the cylinders or otherwise in a designated shielded tank and the resulting acetylene can be released in a controlled proper measure to the cylinders' chamber in order to activate the required explosion. The designated shielded acetylene generation tank can in one embodiment have double walls where the space between these walls is filled with such material as acetone solution or acetic acid that can trap any escaping acetylene gas.

Finally, in a certain embodiment, due to the explosive nature of the formed acetylene, acetylene formed in the process of water and calcium carbide as described herein does not necessarily has to be utilized for the movement of pistons in cylinders causing movement in a vehicle but rather it could be utilized for the generating force in a jet like propelled vehicle, as long as safety measures exist to contain the volatile acetylene and what is emitted to the environment.

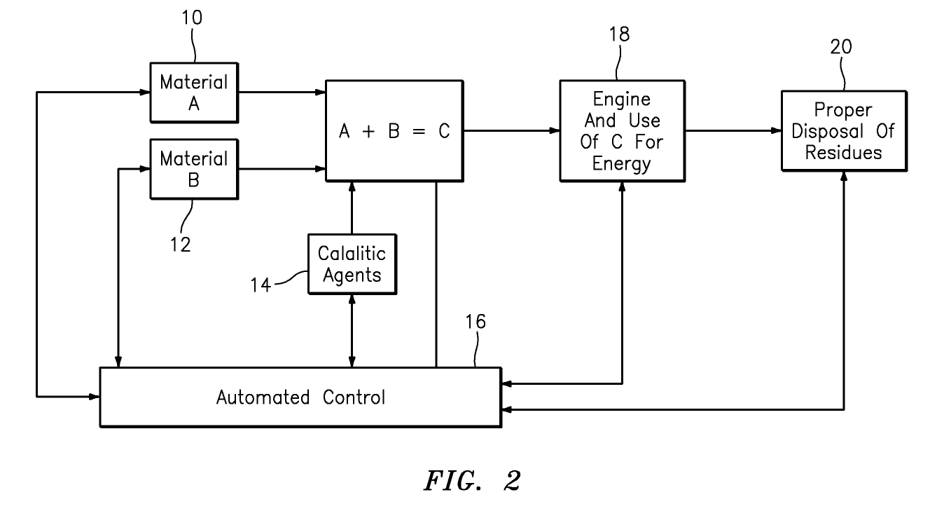

For practical purposes of using such or related processes for engines or modified engines of vehicles, one has to consider safety and environmental factors either for residue of the chemical reaction or in case of collision and exposure of the materials to the open environment. Thus, it should first be noticed that any such vehicle will not be transporting any acetylene, which is prohibited by Federal law (USDOT), but rather the substances (water and calcium carbide that are safe and transportable and the acetylene is only formed in the temporary contained reaction described where it disintegrates rapidly and results in the ensuing explosion. Therefore, one must go through safety stages. As shown in FIG. 2, Material A 10 and Material B 12 should each be housed separately, each being harmless by itself, and being able to interact with each other in 15, with the use of a catalytic agent 14 when appropriate. Next, by automatic control 16 (e.g. a microprocessor and sensors), a substance C made of A and B will be formed, preferably in small quantities such as only those quantities needed for the immediate reaction that will deliver energy. The substance C will be delivered to an engine or propulsion mechanism 18 and used to create mobile energy. The automatic control 16 may be used to operate the engine or propulsion mechanism 18. Thereafter, as shown in box 20, any residue will be properly disposed of.

The following considerations may prevail. The actual quantities of substances A and B should allow their practical storage in a vehicle, i.e. feasible with respect to the size of tanks in the vehicle and weight. For example, in the embodiment of water and calcium carbide generating acetylene, it is known that one pound of good (not pure) calcium carbide can yield 4.5 to 5 cubic feet of acetylene.

In the case of a vehicle engine utilizing acetylene as a result of calcium carbide mix with water, areas considered sensitive to acetylene escape may be protected by such measures as a chambers containing acetone solution or acetic acid, capable of trapping the acetylene and render it safe from explosion where it is not desired.

The economics of resources favor such technology as can be seen from crude comparison of current prices of ingredients required. While a gallon of gasoline sells (in early 2008) for approximately $3.00, the approximate costs for one pound of carbide is 3.7 cents, water is 0.15 cents per gallon and the acetone needed for protection is approximately 50 cents per pound. Economics of scale would further reduce the price for the needed ingredients.

It should be emphasized that one must trap any acetylene gas that either escapes the cylinders or is residual to the explosion and either neutralize it or harness it for further use. Further, one also needs to mine the acetylene trapped in the acetic acid of the semi-porous walls of the engine set as protection. Likewise, one will have a muffler type (that is not muffling noise but capturing acetylene gas) that will capture all residual acetylene and neutralize what cannot be recycled, in order to ascertain it is not released into the atmosphere and neither does it become a cause for explosion. Further, the Department of Transportation does not allow travel with acetylene in cars and even though it is aimed at a different situation of transporting tanks with acetylene, one needs to make sure that one really does not travel with loose acetylene in the car, except during the process of combustion when acetylene is generated on the fly. Notwithstanding all the aforesaid, close attention needs to be paid to it.

In one embodiment, there is an enclosing envelope wherein it is basically a tank filled with acetic acid and surrounds the water-carbide combustion engine. The material of the engulfing tank is strong enough to withstand shocks from the roads and light impacts but disintegrates on a serious impact or collapse of the car, causing all the acetic acid to spill out on the engine, capturing any acetylene and thereby eliminating any potential hazard.

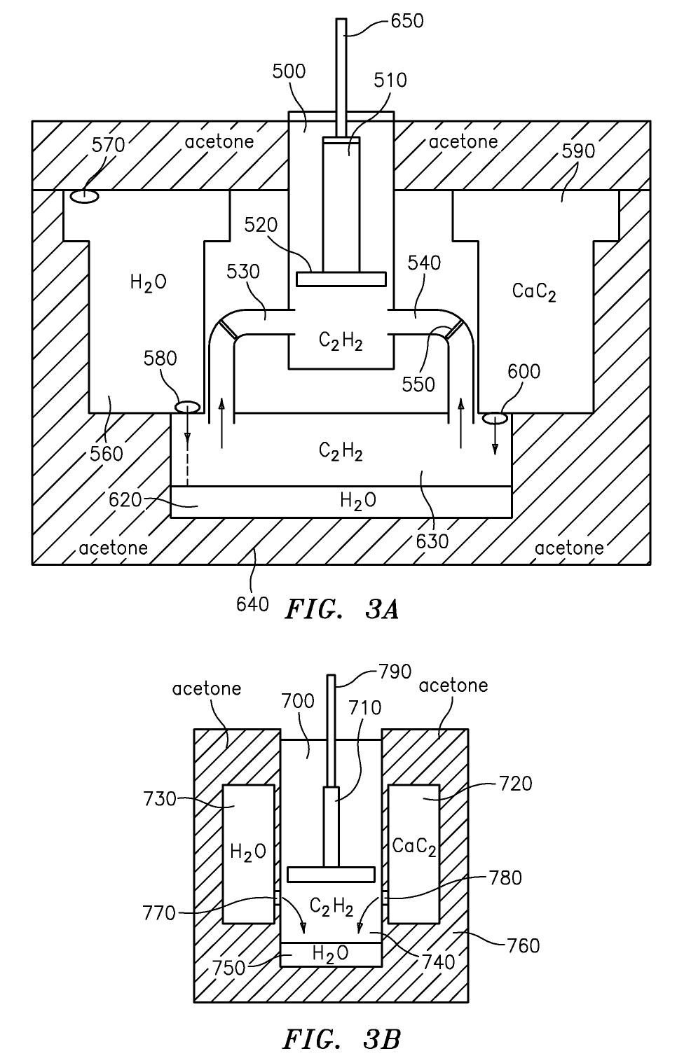

FIG. 3A illustrates a conceptual cross section of an embodiment for a cylinder in a vehicle engine, where the propelling explosion is created by acetylene rather than by an air and gas mixture triggered by a spark and where the acetylene is produced in a different chamber than the cylinder, then moves into the cylinder's chamber. The cross section is for one of the cylinders containing a piston in an acetylene gas vehicle engine. The orientation of the drawings both in FIGS. 3A and 3B alerts to the fact that one of the ingredients for the interaction is water and due to gravity effect the chamber is positioned below the piston rather than at the top, though other embodiments are of course possible. The piston 520 is inside a cylinder 500 to which at least one intake pipe 530 and here a second intake pipe 540 enable the acetylene gas to enter but not leave. Said intake pipes receive their acetylene gas from the reaction in the chamber 630. The acetylene in the chamber 630 occurs when water from the holding tank 560 lets its water out into said chamber and the controlled amount of carbide (CaC2) released from its holding tank 590 through its opening 600 interacts in the chamber 630. The water and carbide interact in the chamber 630 producing the acetylene gas. Sensors and valves, such as those numbered 550 may control the amounts of acetylene allowed into the cylinder's chamber. The whole system is inside a double wall 640 that is filled with liquid, such as acetic acid or acetone, trapping and neutralizing any escaping acetylene gas before it reaches the outer environment. The acetylene formed in the cylinder 500 pushes outward the piston 510 causing a likewise outward movement of the crankshaft 650 and thereby enabling a vehicle for example to move.

FIG. 3B illustrates the concept of acetylene formed inside the chamber of a cylinder showing a cross section of such a cylinder. The enclosure 760 is filled with liquid, such as acetic acid or acetone, trapping any escaping acetylene and inside of it are the water holding tank 730 with the outlet 770 into the cylinder's chamber 700, the carbide holding tank 720 with the outlet 780 into the cylinder's chamber 700. The piston 710 is pushed outward inside the cylinder 700 when the acetylene is formed inside the cylinder's chamber 700 as a result of the water inside the cylinder's chamber 750 coming in contact with carbide received through the outlet 780 from its holding tank 720. The outward motion of the piston 710 pushes the crankshaft 790 thereby providing mobility to a vehicle or for other use as desired.

It should be noted that there are other materials beside acetone that can trap acetylene, such as acetic acid. In fact acetic acid is currently cheaper than acetone. However, the absorption capacity of acetone is much higher (volume acetylene dissolved of 2500 at 15 degrees centigrade and 1250 at 50 degrees centigrade, compared with 600 when acetic acid is utilized) and therefore the preferred embodiment chosen is that with acetone.

There has been disclosed herein the utility of energy produced by rotating axle/wheels of a vehicle for mobility of vehicles and for storage, as well as the acetylene internal combustion engine. Another embodiment for two materials interacting to produce the internal combustion engine without resorting to the air and gasoline mix is the sodium azide internal combustion engine. Namely, Sodium Azide is made of Sodium and nitrogen (NaN3) that decompose into sodium metal and nitrogen gas when decomposed upon the triggering of an electric pulse. Such decomposition creates an instantaneous large volume of air that can be utilized in pushing outward the piston in a cylinder of a vehicle. Calculations indicate a cost of approximately 0.7 cents to 0.8 cents to inflate a volume of one liter.

Various embodiments containing a combination of the above technologies can be utilized for vehicles and other energy requiring operations. For example, in a certain embodiment current produced by the moving wheels of a vehicle can energize the engine for forward motion of the vehicle, augmented by a DC engine, or an internal combustion engine, such as when air and gasoline are mixed to cause an explosion when ignited by a spark. Such embodiments can reduce significantly the consumption of such resources as gasoline, diesel, or the size and weight of a DC battery. Other embodiments, can combine the current produced by the moving wheels of a vehicle with an acetylene engine as described in this instant disclosure, thereby reducing the amount of resources, such as carbide, magnets size and conductors used in the wheels of vehicles.

Another way to mobilize vehicles, such as for forward movement is to use magnets with increased magnetization, causing forward movement. Such linear magnetic motors have been utilized by Disney for quite some time in their speeding vehicles and is now being considered by the Navy and by NASA. Such linear magnetic propulsion can be utilized in newly constructed or modified vehicles, where towns equip their roads, such as on the sides of the roads with magnets. In order to slow down the vehicle in a controlled way, whether just to slow its speed, wishing it to stand still or needing to make a turn, as well as for reverse motion, the car can activate an internal magnet (e.g., electromagnets) with opposite polarity. Thus, vehicles equipped with such apparatus can shut off their engines operated by other methods, such as by an internal combustion engine and succumb to motion resulting from the magnetic force supplied by the city, other governing locality or operational entity. In a business model, such supply by a city can also be a source for revenue for it, where the city can initially amortize the cost of construction, the electrical bills if electromagnets are involved, maintenance, etc. and then generate profit for the city by charging a fee to vehicles operating within such magnetic force. Further, vehicles equipped with such technology as an adjunct to any other technology utilized for mobility could shut off their non-magnetic propulsion technology when entering a city with such magnetic powering and advance and do other mobile activities only by utilizing the magnetic force provided by the city. City is used here for brevity, but it can be any other suitable operational facility. The winner here will be the environment when such technology will be used.

The innovation to this technology is both on the business model as well as on the technological aspect. On the business model, it calls for localities to supply magnetic force and enable vehicles entering and operating within its jurisdiction and such supply of magnetic force, the ability to be mobilized and operate in an environmentally friendly manner and where each such vehicle is charged for operating within such territory. On the technical level, the innovation is utilization of opposite polarity magnets, where their usage is timed, for example by supply and withdrawn of the local electrical power in the vehicle to magnetize the magnets with the appropriate polarity for the slowing down, breaking and reverse motion function. Alternatively, vehicles could have simple, non-electromagnets that are flipped 180 degrees at will. That is, such internal magnets are positioned in the direction providing same polarity of the external magnets when propelled ahead and flipped mechanically to the opposite direction when the opposite polarity is needed to slow down the vehicle and stop. Further, there could be a plurality of such simple non-electromagnets that can be flipped to opposite polarity at will, thereby increasing the amount of resistance to forward movements with any additional magnet so flipped to opposite direction; i.e. polarity.

When operated in conjunction with the electrical power provided by the wheels as described in the instant disclosure one obtains a further economy of resources that are environmentally friendly. Namely, in one such an embodiment, utilizing an electromagnet in a vehicle in conjunction with generation of current from the wheels, one can provide the needed current for the electromagnet to supply the force needed for mobility and once started the wheels will continue to empower the magnet through the coils on the electromagnet. In the Disney operation, it suffices to stop the magnetization to cause the slow down and stopping of the vehicles; namely an external intervention in mobility. However, when the vehicles are individually operated and controlled from each such vehicle that may have different individual needs, a different solution is required and hence the innovation described herein.

With a greater expense, highways can also be equipped with magnets and vehicles equipped for such operation can shut off (voluntarily or automated) their engines operated by other than magnetic energy and be propelled ahead via the magnets situated along their path, though it would appear at present to be cost prohibitive.

Electromagnetic induction can be utilized in yet another type of innovative propulsion technology when superconducting materials are utilized. The basic principle of the technology rests on utilizing DC current flowing in two independent closed-loop circuitries made of superconducting material, each altering its direction of flow on cue of a processor controlled diodes. Such a circuitry results in induced alternating current in a conductor looped adjacent to it. We utilize this principle as disclosed here for a vehicle that is operated on alternative energy, extending its range of travel without energy replenishment. Alternatively, this principle can be used for other purposes, such as generation of AC in a vehicle for recharging DC batteries, energizing a flywheel or for supplying the national grid.

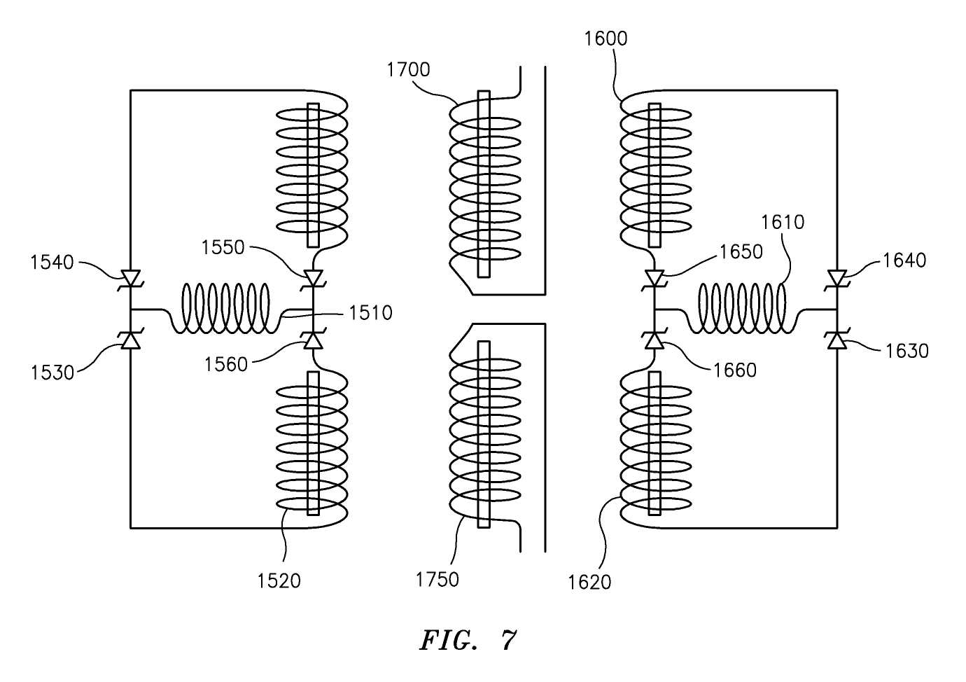

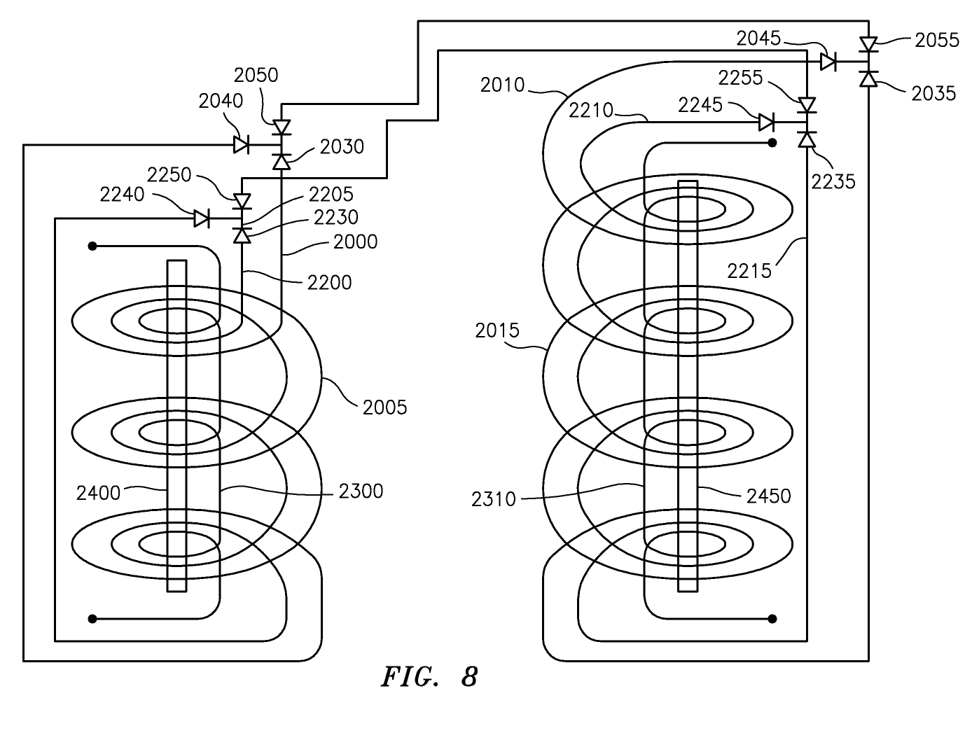

If not for the energy consumed by the diodes that are essential for redirecting the direction of flow in each of the superconducting circuits, the process of continued operation would have lasted much longer. To this end, any person skilled in the art can construct a circuitry with capacitors and resistors fed by an external (i.e., outside of the superconducting loop circuitry) supply of energy for the diodes to further reduce the energy loss of the DC due to the diodes. Thus the resulting range of travel is extended before additional external energy would be required. FIG. 7 provides an introduction to the technology discussed and FIG. 8 provides an illustration of an actual “two-stroke” superconductivity generation of energy.

A properly constructed two-strokes superconductivity energy generator (“TSE”) abiding by the laws of physics would contain for each half of the duplex forming the two-stroke TSE, two separate superconducting wires looped on the same ferromagnetic bar whereas the DC current flows in each of them in an opposite direction to each other and only one of them is carrying charge at any one stroke, as allowed by the relevant diodes.

A reciprocal similar construct (the second half of the duplex) is connected to the first half duplex, utilizing diodes gatekeepers as described above and provides each of the superconducting wires in the reciprocal construct the second-stroke functioning as allowed by the diodes. FIG. 8 illustrates the two-stroke energy production as described.

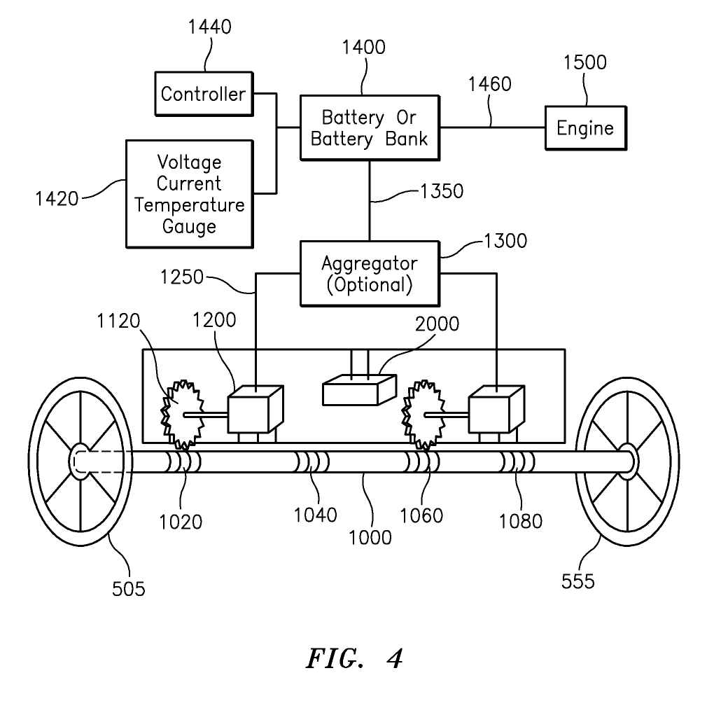

FIG. 4 illustrates a vehicle axle 1000 and a pair of primary wheels 505 and 555 of the vehicle. The axle 1000 has in this embodiment four worm gears 1020, 1040, 1060, and 1080. When the axle 1000 rotates, so do the worm gears, such as the worm gear 1020. It causes rotation in the secondary wheels 1120 that causes the generator 1200 to produce electrical current 1250 that flows to an optional aggregator 1300. The current flows from the aggregator 1300 to the battery or battery bank 1400 through the conductors 1350. If there is no aggregator 1300, then the produced current 1200 flows directly to the battery or battery bank 1400. The voltage, current and temperature of each battery may be monitored by monitor 1420 and when excesses occur, such as heating up during recharge, the controller 1440 stops the recharging of that battery and redirects recharge to another battery. Current may flow from the battery or battery bank to the engine 1500 of the vehicle through the conductors 1460.

When the axle 1000 is either a magnet or has magnet(s) attached to it, there is no longer any need for said worm gears and the generators in 1200 are replaced by stationary armature with conductors. While energy may flow out from the conductors as the axle rotates, the combined rotating axle and stationary armature with conductors are now the generators feeding the aggregator in 1300.

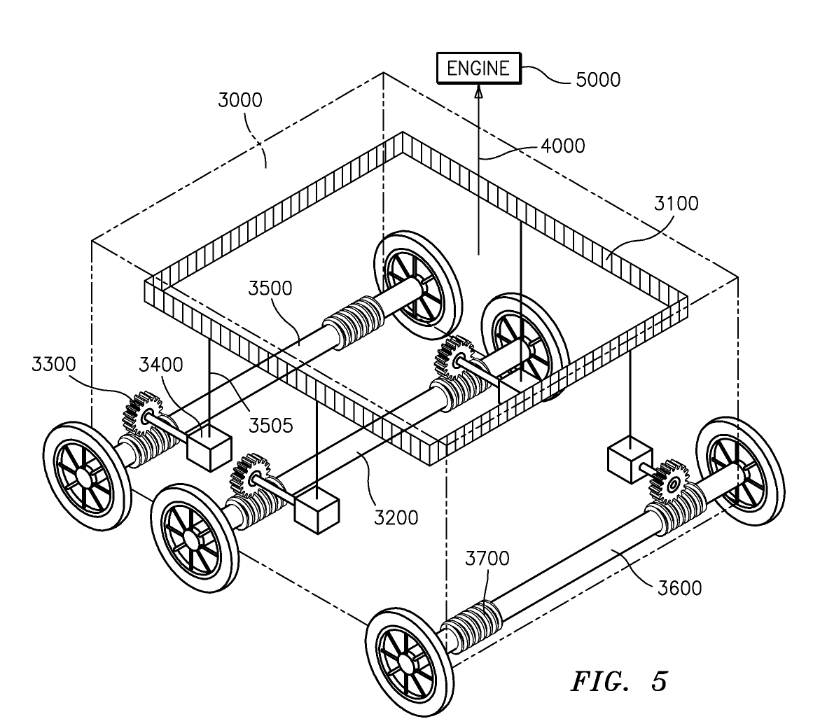

FIG. 5 illustrates the Embedded Generator Cart (EGC) 3000. The illustrated embodiment shows three axles 3600, 3200, and 3500. Each of the axles has two worm gears, such as the one identified by reference numeral 3700. The worm gears in turn cause rotation in a plurality of secondary wheels 3300, each of which is connected to an electrical generator 3400. Each generator 3400 thus generates electricity that flows via conductor 3505 to the battery or battery bank 3100. From there, the current may flow through at least one conductor 4000 to the engine 5000 of the vehicle.

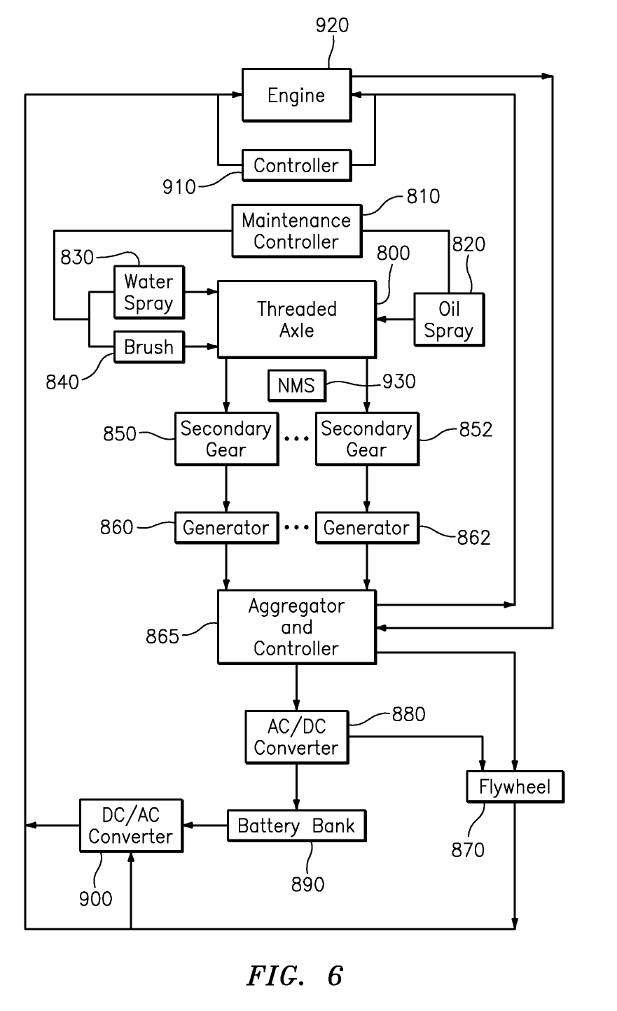

FIG. 6 illustrates an environmental protective embodiment wherein the vehicle may have a plurality of threaded axles 800 connected to a plurality of wheels (not shown). Each threaded axle 800 activates a plurality of secondary gears 850, . . . , 852 that are connected to and activate the generators 860, . . . , 862. The electricity produced by the generators 860, . . . , 862 is collected by the aggregator and controller 865. Part of the AC energy in the aggregator 865 may flow for storage in a flywheel 870 and part of the AC energy may be converted to DC via the AC/DC converter 880 so that the converted energy can be stored in the battery bank 890 or the flywheel 870 if it is a DC flywheel. To utilize the stored energy from the battery bank 890 for an AC engine 920, the energy withdrawn from the battery bank 890 is first converted back to AC energy via DC/AC converter 900. The energy stored in the flywheel 870 may move from the flywheel 870 directly to the engine 920 if it is an AC flywheel and in case of a DC flywheel moves first to the DC to AC converter in 900, while the controller 910 ascertains proper amounts and timing. The engine 920 can receive AC current directly from the aggregator 865 as well as provide energy to it. Useful accessories in this system include the Noise management System (NMS) 930 and the cleaning and oiling of the threaded axle 800 if exposed to road contaminants and the elements, done by water spray 830, brush 840 and subsequent oil spray 820.

FIG. 7 illustrates the principle leading to a Superconducting Energy Generator (SEG). DC current flows in coil loop 1500 and during the first stroke is allowed to pass through the diode in 1540 but blocked by the diode 1530. This determines its flow in the circuitry through the conductor(s) 1500, through the diode 1550 but blocked by the diode 1560. In the second stroke, the diode 1540 is now blocking the current flow, while the diode 1530 is letting it pass through. This determines its course in the direction opposite to the first stroke where it passes through the conductor(s) 1520, allowed passage through the diode 1560 but blocked by the diode 1550. The current flowing in the “mirrored image” 1600 also flows in two strokes. However, the strokes are the controlling factor for creating alternate current in coil 1750 and in coil 1700 because when current flows in coil 1520, the “mirrored circuitry” has the current flow in coil 1600, while there is no flow in coil 1500 and in coil 1620. In the next stroke, current flows in coil 1500 and in coil 1620 but not in coil 1520 and coil 1600. Thus, alternating current will flow in coils 1700 and 1750 resulting from the induced fields generated by the Direct Currents in the circuitry 1510 and 1610. Since the DC currents are flowing in superconducting conductors there will be negligible loss to heat and a long duration of flow. Any person skilled in the art can construct a circuitry of capacitors and resistors to further minimize reduction DC energy by the diodes. FIG. 8 illustrates an actual generation of energy utilizing the introduction provided by FIG. 7.

FIG. 8 Illustrates a two-stroke superconductivity engine. DC Current flows in the superconductor 2000 in the direction towards line 2005 and arrives at the three diodes 2040, 2030 and 2050. In the particular cycle illustrated, the current is let through the diode 2040 but blocked by the diode 2030 from continuing to flow in its loop. The current is allowed to flow by the diode 2050 but blocked from reversing its flow by the diode 2040 and proceeds to flow in coil 2010 towards line 2015. The current is allowed to proceed by the diode 2035 and once it has established itself in that circuitry is then blocked by the diode 2035 from reversing its flow and also blocked by the diode 2045, but is allowed to flow by the diode 2055, thereby leaving its current circuitry and returning to flow in coil 2000 as it is let through by the diodes 2050 and 2030 but blocked by the diode 2040.

While the DC current was flowing in the superconductor 2010 and was not flowing in the circuitry 2000, another unrelated DC current was flowing in the superconductor 2200 towards line 2205 that is flowing in the opposite direction of the other DC current that previously demonstrated a flow in circuit 2000. Namely, flowing towards the diode 2240 that lets it through and so does the diode 2230. Once the DC current is established in that superconducting circuitry from the diode 2230 towards and through the diode 2240, it is blocked by the diode 2230 from reversing its flow but is allowed to pass through the diodes 2250 while not being let through by the diode 2240. The diode 2245 however enables it to establish flow in another circuit starting with its passing through the diode 2235 but blocked by the diode 2245 so that it proceeds toward line 2215. Once that current has established its flow in this circuitry, it is blocked by the diode 2235, but allowed to pass through the diode 2255 while blocked from reversing its flow by the diode 2245 that allowed its flow only in one direction.

The ferromagnetic bars 2400 and 2450 around which the superconducting wires are looped define the respective “stroke” locations in the illustration. Thus, DC current is always flowing in a circuitry of each of the strokes, but is always in the opposite direction to the previous DC current that was flowing in that stroke location before the DC currents exchanged stroke locations.

The resulting effect is that each of the ferromagnetic bars becomes magnetized, but change polarity with change of flow direction in each of the respective circuitries. The change of polarity affects a change in the magnetic field of the ferromagnetic bars and that change causes an AC current in the respective loops 2300 and 2310 that can respectively be collected for usage.

Thus, there is illustrated a “two-stroke” superconductivity energy generation with doubling up on the amount of energy generated as a DC current can be maintained in any one of the superconducting wires without recharging for a considerable amount of time, as it flows independently in one circuitry at a time. While a larger number of circuitries can be constructed for multiple-stroke energy generation, by diverting the DC current to them and duplicating further generation of AC current, the two-stroke circuitry is the atomic basic unit for such energy generation.

The energizing of diodes by external energy source would apply here as well, though not shown in this illustration.

The floor of a vehicle may contain on its surface or just below it piezoelectric material that will emit electricity when pressed upon by a load, such as cargo or people. Further, the wheels of a vehicle bounce up and down due to road imperfections and every such bouncing can apply pressure to piezoelectric material positioned in appropriate place(s) in the vehicle, such as where the shock absorbers receive the impacts from the bouncing. Since the wheels bounce up and down, the piezoelectric material will generate electricity in one direction upon the pressure applied to it and electricity in the opposite direction when the pressure is withdrawn, leading to alternate current generation in the vehicle. Such current needs to be amplified in order for it to be suitable for actual vehicle purpose of mobility or remittance for external use. The amplification process relies on polarities of piezoelectric transformers and is provided below.

A piezoelectric transformer is constructed from elements with different polarization that are of same size and utilizing material, such as ceramics that has a high dielectric constant. The two equal sized parts store the mechanical energy and enable to convert up or down. As is known in the art, piezoelectric transformers may have two sets of electrodes on the piezoelectric material; a primary electrode positioned in the direction of the thickness of the material and secondary electrode positioned in the length direction of the material. Applying voltage with the resonance frequency to the primary electrode brings about a mechanical vibration in an inverse to direct piezoelectric effect, resulting in a high voltage output from the secondary electrode

A succession of said piezoelectric transformers, where the low voltage input to any piezoelectric transformer is the high voltage output from a preceding piezoelectric transformer will lead to a current amplification in the vehicle, starting from a low voltage obtained from an initial application of mechanical force to the piezoelectric material and ending with the higher voltage supply for storage and delivery. Such current amplification process combined with the initial current generation by the piezoelectric material to which force was applied produces our innovative Piezoelectric Current Generator suitable for vehicles and other applications.

Further, we can economize vehicle cost on electric generation with wheel chargers/axle generators by utilizing a smaller generator, take the output voltage from said generator and feed it to a set of successive piezoelectric transformers to get a final desired strong enough energy that will be fed to the storage device utilized or used directly for the motor.

Said set of successive transformers may also be utilized to increase the voltage by permutations of repeated cycle. For example, in a set-up of 3 piezoelectric transformers, we feed energy at voltage (V1) to transformer A and get a larger voltage output as voltage (V2), feed voltage (V2) to transformer B and get an even higher voltage, voltage (V3) that is fed to transformer C to get a higher voltage (V4). The cyclic amplification is established when voltage (V4) is fed back to transformer A getting an output voltage (V5) that is fed to transformer B getting an output voltage (V6) that in turn is fed into transformer C to get a higher voltage (V7) that can now be fed again to transformer A, etc. That is, our innovative Piezoelectric Energy System (PES) in the case of successive amplifications with permutations is summarized as:

(V1)<(V2)<(V3)<(V4)<(V5)<(V6)<(V7)< . . . <(Vn).

If mobilizing the vehicle is the only goal and there is no interest in saving any superfluous energy for remittance to the national grid, then no additional storage is required, the Energy Cycle Drive Train may not be utilized and the expense for fitting a vehicle with axle generators (collectively referred to as axle generators) drops drastically. We may also add piezoelectric (PZT) power generation in a vehicle as disclosed herein. Said PZT power generation in vehicles without intermediate storage needs is facilitated by the following observation.

It has been pointed out by H. Sodano et. al, in Electric Power Generation Using Piezoelectric Devices, Center for Intelligent Material Systems and Structures, Virginia Polytechnic Institute and State University Blacksburg, Va. 24061-0261, USA, that the amount of power in PZT generation can be estimated ahead of time and may be immediately available for powering other devices without having to go first to a capacitor. Thus, PZT energy generated on board of a vehicle may supplement other energy generation for direct mobility without intermediate storage, such as by axle generators. Nonetheless, PZT energy generated may be added to storage in a vehicle if desired.

Thus, in this embodiment, we enable a direct flow of energy from the axle generators directly to the motor that mobilizes the vehicle with supplemental mobility or energy, as needed coming from other areas on the vehicle, such as:
(1) Supplemental mobility in the form of a combustion engine using its traditional functions guided and enabled by a controller allowing mobility through a separate axle.
(2) Electric battery in an electric or hybrid vehicle that when needed augments the axle generators energy provided the motor, based on decisions and enabling of a controller.
(3) Piezoelectric energy generated by pressure applied to the suspension system in the vehicle.
(4) Stored energy in a storage facility, such as flywheel(s), ultracapacitor(s) or dedicated battery for such purposes.
(5) Any other energy available to the vehicle that is known in the art.

PZT energy may also be generated, as part of the suspension system in a vehicle and used for any desired purpose. Said generated PZT energy may also be amplified by PZT transformers. Pressure on the isles' surface along the row of seats and when economical also in front of the seats in such transportation instruments as a bus a train or an airplane that were fitted with PZT transducers underneath may provide energy resulting from passengers treading on said surfaces. Further, positioning a layer of PZT transducers on top of the gas and brakes pedals in a vehicle may likewise generate energy that can be added to the energy pool in a vehicle. Further, PZT transducers fitted underneath seats in vehicles may likewise produce bursts of energy as well.

Though not directly related to vehicles, it should be noted that energy may be generated and harvested from PZT transducers (stacked and in combination with PZT transformers when appropriate) placed under waterfalls, on the sea side of breakwaters, or utilizing the force the sea impacts during tide periods. Due to causality the latter could be termed as Lunar PZT Energy.

The piezoelectric energy generation in vehicles addressed herein avails its generated energy to operate in tandem with the axle generators when useful, in any of the preferred embodiments of the hybrid vehicles.

Further, reference herein to piezoelectric energy generation includes single and various combinations of piezoelectric components, such as a single PZT transducer, a stack of PZT transducers, a PZT transducer with a PZT transformer or a stack of PZT transducers and at least one PZT transformer or a combination of any of said variations.

Shock absorbers in a vehicle can deliver a force of up to 3000N (some 675 lbs.) in contraction and 2500N (some 562.5 lbs.) in expansions. In utilizing such force we intercept it before it goes through the dampers in the vehicle. Thus, in one embodiment, the Suspension Piezoelectric Generator (SPG) in the vehicle may have a protective plate positioned between the impact and the piezoelectric transducer(s). To harvest the generated energy, we equip the output from the transducer with a collecting conductor that may have an appropriate external resistor as part of the circuitry in order to ascertain a desirable current output.

Further, a single piezoelectric transducer may fall short of the desired amount of energy and enhancing measures may take place, such as:
(1) Stacking up piezoelectric transducers, amplifying the output according to the added layers.
(2) Utilizing PZT transformers.
(3) Utilizing a series of PZT transformers where each output voltage is fed to the next successive PZT transformer.
(4) Utilizing a combination of stacking up PZT Transducers and PZT transformers.

PZT transformers may also be utilized to enhance voltage output from any energy source in the vehicle, such as flywheel (s) or ultracapacitors(s).

PZT transducers and energy amplification, when appropriate is not limited only to transportation and can be utilized in other situations, such as elevators. Elevators can generate alternative energy in at least one of PZT transducers and energy generated via IRVS and their generators. The PZT transducers may be positioned under the floor of an elevator and absorb pressure from passengers stepping and walking on them that is further enhanced by gravity as the elevator ascends. Further, the pulley in the elevator can be equipped with a set of at least one IRVS(s) system connected in series for enhancing rotational energy that provides torque to a generator. IRVS(s) connected in series benefit from providing the primary gear in each IRVS with a direct hook-up to the last pinion in the IRVS before it, capturing its rotational velocity, while its own diameter is larger than said pinion. The resulting effect is increased rotational velocity. Alternative energy generated by the activity of an elevator by at least PZT transducers and IRVS system with generators can be used directly or stored appropriately.

The PES can be further utilized for storing energy at a lower voltage and transforming it to a higher required voltage when needed. For example, we let a 2 KW flywheel emit energy; pass it through the Piezoelectric Energy System (PES) to obtain a higher voltage level, such as resulting in 7 KW, or increase a 48 volt ultracapacitor to a higher voltage, such as 144 volts by passing the output of the ultracapacitor through a PES.

However, when utilizing piezoelectric step-up transformer utility in the PES for our Energy Cycle Drive Train, it may not be recommended to use each transformer more than once in a cycle since the flow of energy is continuous and each transformer used needs to be ready for the next pulse coming through, rather than enhance a previous pulse. That is, PES without permutations. Further, it ought to be remembered that higher voltages require larger transformers; namely, increased length of each ceramic piezoelectric element of the voltage output portion. Its significance relates to the consideration for the number and magnitude of transformers used for a PES in a single location, such as a vehicle due to space limitations.

Since voltage increases by 15% to 20% in each utility of a piezoelectric transformer, we can estimate six to eight successive cycles starting from 48 volt and reaching the 144 volts needed for the electric motor in the vehicle. Thus, we can utilize a single 48 volts ultracapacitor for such purpose, which will reduce it from the otherwise required three ultracapacitors needed in today's state of the art. With the price of piezoelectric transformers being less than ultracapacitors, an overall savings is realized in product cost, especially that The Energy Cycle Drive Train with ultracapacitors may otherwise require nine 48-volt units to minimize heat losses in the ultracapacitors in rapid charge and dissipation cycles, rather than three 48 volt ultracapacitors where each utilizes the PES.

Further, we disclosed multiple flywheels rotating at fast rotational velocity exceeding tens of thousands rpm. Said multiple flywheels can be built in an array of individual lower energy level flywheels that when combined deliver a higher required energy. Further, at least one of a said array of lower energy flywheels and at least one individual flywheel(s) may utilize the PES to reach a higher voltage output. Any person skilled in the art may construct combinations of PES with either individual flywheel(s), an array of flywheels with PES or any suitable combination of both.

The principles of storage systems and PES can be utilized beyond vehicles, such as for plants where power is needed, for power producing facilities supplying the national grid, or in home appliances.

In another embodiment, direct flow of energy is enabled from the wheel chargers or the axle generators directly to the motor that mobilizes the vehicle, with supplemental mobility or energy provided, as needed, coming from other areas in the vehicle. Said supplemental mobility or energy may be at least one of a combustion engine or other type engine, electric battery in an electric or hybrid vehicle, Piezoelectric energy or stored energy in a storage facility, such as flywheel(s), ultracapacitor(s) or dedicated battery for such purposes.

The piezoelectric energy generation is addressed herein as part of the axle generation and in any of the preferred embodiments provided and when appropriate, works in tandem with the axle generators or supplies energy on its own, under the appropriate controller's decision and enabling.

A controller monitors the electric power delivered to the electric motor and decides and enables the appropriate said added energy to be supplemented to the motor or the mobility augmented facilitation.

Further, the controller that may be at least one of a set of at least one controller for each function or an encompassing controller may also decide and enable instances of mobility by other methods. Such methods may be a combustion engine during such instances where it may be more efficient and/or economic to do so, while maintaining the axle generators as the primary source of energy when possible. Further, said controller(s) may also enable recharge of and dissipation from a storage facility that may augment when appropriate, the energy provided the motor by at least one of the, axle generators and piezoelectric energy generators.

In the preferred embodiment of Axle Generators hybrid vehicle (combustion and axle generators), the vehicle is powered through the involvement of at least two axles. One axle is a dedicated combustion engine axle (CEA), whereas at least one other axle is fitted with IRVS leading to the axle generator(s) (AG). The smart controller overseas the activities of the CEA and AG and allows them to operate as appropriate. Vehicles with more than two axles may be fitted with additional IRVS units and generators on the additional axles.

In the preferred embodiment of a hybrid electric vehicle (electric vehicle and axle generators), the vehicle is powered by the axle generators and receives additional energy from the battery when appropriate, as judged and enabled by the controller. Said controller is programmed to minimize dissipation from the battery whenever possible, allowing the axle generators to be the primary power source for the vehicle. Said controller decides and enables partial dissipation from the battery to the motor to augment any power deficiency from the axle generators and piezoelectric energy generators or take over altogether depending on circumstances.

In the preferred embodiment of a triple hybrid vehicle (combustion, electric, and axle generators with possible piezoelectric energy generators), the controller decides and enables the most efficient mobilization scenario, with axle generators and piezoelectric energy generators receiving a preferred activity mandate and augmented by at least one of the combustion activity or battery energy.

A vehicle may be built with alternative energy technology disclosed herein in any desired embodiment, or be converted from another energizing system to a hybrid energizing system that also includes an embodiment of the alternative energy system, such as the axle generators technology and/or the Suspension Piezoelectric Generator technology. A preferred embodiment of the axle generators technology is provided below.

The invention relates to alternative energy for vehicles. Specifically, it entails extending mileage driven by a vehicle irrespective of its propulsion method, such as fuel, electric, or hydrogen. Said extending mileage driven capacity is achieved by turning a mobile vehicle into an electric generator, either without or on top and beyond regenerative energy from braking power of the vehicle. Such generated energy is stored on board and utilized for significant added mobility. Any surplus stored energy may be remitted to the national grid.

The vehicle is equipped with magnets and conducting coils set up in proximity to each other, allowing one of them to rotate while the other remains stationary. The rotations are on account of any rotating part in the vehicle, such as the axle(s) during mobility. The wires of the conducting coils cut into the changing magnetic field thereby generating electromagnetic energy.

There are several points of concern right from the outset, which need to be addressed as challenges and are resolved in the present design as follows. (1) Form factor of a vehicle chassis containing a rotating part, such as the axle and its immediate surrounding is insufficient to contain sufficiently large coils set up; (2) The average rotational velocity of an axle is insufficient for generating sufficient electrical energy to mobilize a vehicle, or in other words, insufficient voltage and power to impart sufficient torque to the motor driving the vehicle; (3) A direct dependency of the motor driving the vehicle to the source of energy generated from mobility is problematic, at least from the appearance of violating the laws of physics. (4) Charging and dissipation times for storage on board of vehicles is too lengthy for a practical vehicle product of the targeted design; finally (5) Storage devices of current technologies cannot absorb and dissipate energy simultaneously, let alone the fact that they are bulky, heavy and expensive.

Each of these issues has already been addressed and initial resolutions have been formulated and summarized below.

To obtain appropriate rotational velocity suitable for the desired generation of electromagnetic energy we employ our Increased Rotational Velocity System (IRVS) unit affixed to an axle. The IRVS is composed of a set of sprockets or gears that are interconnected and are increasingly of diminishing diameters resulting in successively increased rotational velocity. The initial, largest by size and slowest sprocket or gear is attached to the axle either directly or through at least one bevel gear. The final pinion gear in the series with the highest resulting velocity is responsible for the rotations of the magnets or the coils. The teeth on the gears are coated with heat dissipating chemical, allowing extended operation without overheating. Heat dissipating material may be any known in the art, such as the Alpha Gel that is a soft silicone made by Taica Corporation of Japan or the patented solid film lubricant of Tribology System Inc (TSI) invented by Lewis Sibley. Further, we can affix multiple IRVS units to various rotating parts located in a vehicle, such as at each end of any axle, generating sufficient rotations and reciprocal energy generation, thereby multiplying the amount of generated energy. It can certainly also be affixed to any desired location of the axle.

Said successive gears with diminishing diameters may be connected (i.e., teeth in groove) externally to each other, or be of an internal configuration, where at least one of said gears has an inverted teeth configuration being on its inward circumference. In the preferred embodiment of the IRVS, the primary gear that is connected to a rotating axle of a vehicle or to at least one intermediary bevel gear that is connected to said axle, has an inverted teeth configuration; the secondary gear has both external and internal teeth configurations, where its external teeth make contact with the internal grooves of the primary gear; and its internal teeth make connection with the external grooves of a tertiary gear that has external teeth configuration. The tertiary gear has external teeth configuration making contact with the internal grooves of said secondary gear. The teeth making contact with the grooves may be interchangeable. Namely, if the teeth of one gear connect with the grooves of the other, the other gear might as well have its teeth make contact with the grooves of the former gear. Each successive gear may be of fraction size of the previous one, such as a third or half the diameter of its preceding gear, though in other embodiments other ratios may prevail. In our preferred embodiment the diameter of the secondary gear is one third smaller than the diameter of the primary gear and the diameter of the tertiary gear is one half of the diameter of said secondary gear. Said third gear spinning at six times the rotational velocity of the primary gear can cause a magnet configuration affixed to it to rotate at same velocity, or be connected to second set of IRVS that is identical to the first one, where the primary gear of the second IRVS with its internal teeth configuration is made to rotate at the rotational velocity of the tertiary gear of the first IRVS set. The net result will have the secondary gear of the second IRVS rotate at 18 times the primary gear and the tertiary gear in the second IRVS rotate at thirty two (32) times the velocity of the primary gear in the initial IRVS set and when affixed with magnets would cause said magnets to rotate at 32 times the rotational velocity of the axle in the vehicle.

The preferred embodiment can be translated into revolutions per minute (rpm) according to the speed of the vehicle. For example, if the primary gear of an IRVS of a vehicle traveling at a speed of 40 miles per hour (mph) will rotate at 178 rpm and the tertiary gear of the IRVS will rotate at 1068 rpm. When a second set of IRVS with said connection to the first IRVS set is employed, its primary gear will rotate at 1068 rpm, its secondary gear will rotate at 3204 rpm and its tertiary gear will rotate at 6408 rpm. When the vehicle increases its velocity to 60 mph, the primary gear in the first set of the IRVS will rotate at 275 rpm, the secondary gear at 825 rpm and the tertiary gear at 1650 rpm. Activating an optional second set of IRVS will result in the primary gear of said second IRVS to rotate at 1650 rpm, the secondary gear of said second IRVS to rotate at 4950 rpm and third gear of said second IRVS to rotate at 9900 rpm. Any person skilled in the art can configure the needed rotational velocities desired and machine gears in appropriate diameter ratios, as well as decide how many IRVS sets to connect or activate successively.

Any IRVS system may be vertical, horizontal, or at any angle suitable for the specific type of vehicle it is installed in. Any IRVS may achieve said suitable angle by utilizing any method known in the art. Said method may be a combination of at least one bevel gear starting with a rotating part in the vehicle, such as the axle and terminating in the primary gear of the IRVS.

The energy generated may be supplied directly to the motor or collected into at least one storage device(s) from where some energy is used for mobility and the rest accumulates for optional remittance to the national grid. The storage device utilized may be any storage device known in the art, such as a flywheel or ultracapacitor. The storage device in the preferred embodiment may be at least one of a set of flywheels containing at least one flywheel, a set of ultracapacitors containing at least one ultracapacitor, a combination of both flywheel(s) and ultracapacitor(s), or a battery. Said battery may be at least one battery and may operate either singularly or in addition to said flywheel(s) set and/or ultracapacitor(s) set. Current technology of ultracapacitors enables to group them in a series to achieve a higher voltage at the cost of capacitance. However, our Energy Cycle Drive Train discussed below forgoes the need for large capacitance for mobility purposes, with attention paid to the frequency of charge—discharge cycles due to generated heating.

Flywheels are known in the art, but are sizeable, heavy and expensive. In one embodiment of the instant disclosure we have a flywheel embodiment design similar to the ultracapacitors utilizing the Energy Cycle Drive Train where at least two flywheels partake in the operation, however of a smaller physical magnitude than currently known in the art and are of smaller weight, while rotating at a very fast rotational velocity. Utilizing the physics of flywheels as governed by their mathematical equation for energy storage indicates that if their rotational velocity increase significantly, since it is squared in the equation, it would lead to reduction in diameter and/or mass of the wheel, which may be suitable for our design. Thus the flywheel design includes multiple flywheels, where each may be of a low energy power, such as 2 KW to 7 KW that may be connected appropriately. Each of said flywheels may rotate at a very fast speed that may exceed tens of thousands rpm.

The operation with the embodiment of ultracapacitors is presented first. The vehicle is equipped with at least one IRVS system, Axle Generators, ultracapacitors, controller and motor for propelling the vehicle. Said motor may be mounted as a back-drive in an otherwise front-drive vehicle and a front-drive in an otherwise back-drive vehicle. Said various components may be connected to the chassis of the vehicle utilizing methods known in the art, such as brackets and the IRVS connected at least to the axle or a bevel gear as an intermediate connection to the axle.

The Energy Cycle Drive Train is set for intermittent supply, containment and dissipation of energy. In the ultracapacitors version of storage, we have a minimal configuration set of two ultracapacitors. One ultracapacitor is charged while the other delivers energy to the electric motor driving the vehicle and at some determined point charging is switched to the ultracapacitor that dissipated energy and dissipation starts from the now charged ultracapacitor. Beyond the minimal configuration, the set contains at least three ultracapacitors, where one is in stand-by mode for supplying energy, one is being charged and one dissipates energy. The charging, standby and dissipation operate cyclically under the guide of a controller.

In one embodiment the set up includes four ultracapacitors of 48 volts each, where three are connected in series, enabling the current to apply sufficient torque to the motor propelling the vehicle, while one ultracapacitor is being charged and cyclically rotates with an ultracapacitor from said three supplying energy to the motor. The rotation is not mechanical but rather under the direction of a controller that allows appropriate diodes to pass through current or block it, while the ultracapacitors are all hard wired to the source of energy supply and to the motor being the final recipient of energy.

The Energy Cycle Drive Train may be set to a preferred embodiment where any time the vehicle is already mobile the controller enables switching to electrical Axle Generators drive utilizing the motor that is energized from the charged ultracapacitors. The vehicle returns from said electrical Axle Generators drive to its former propulsion method when appropriate. If the former propulsion was electric battery propulsion the vehicle may utilize the same motor as used for the electric Axle Generators. If said former propulsion was fuel engine propulsion, the gear is brought back out of neutral into proper gear position suitable for further mobilizing the vehicle.

In one embodiment, the timing cycle of the Energy Cycle Drive Train may be set at 12 seconds recharge and 12 seconds delivery when two or more groups of three 48 volts ultracapacitors connected in series constitute a base storage and delivery unit. This setting may however cause excessive heating of the ultracapacitors. Notwithstanding the heating aspect, this assures a continuous delivery of energy from the ultracapacitors to the driving motor. When four 48 volts ultracapacitors are utilized, where a single 48 volts is charged and cyclically replaces one of the other three 48 volts connected in series, becoming connected in series with the other two remaining 48 volts ultracapacitors, energy delivery is not switched around but remain constant. However, heating and loss of energy is anticipated due to the rapid cyclic changes.

In another embodiment that takes said heating into account, a set up of to two sets of three 48 volts ultracapacitors act as the source of energy, where one set of three 48 volt ultracapacitors delivers the energy required for the motor torque while the other set of three 48 volt battery is being charged. The roles of said two sets changes cyclically, where the one that was charged moves next to dissipate its energy and the one that dissipated its energy moves to being recharged. No mechanical move occurs as presented before.

Yet in another embodiment, there are three sets of three 48 volts ultracapacitors per set, where one set dissipates its energy, one set is in a standby mode for dissipation and one set is being charged. The set being charged is the set that prior to it being charged dissipated its energy and the set that is in standby mode is the set that was previously charged.

There is at least one controller with dedicated segments of functionality or separate controllers, each dedicated to at least one specific operation. Controller segments may contain artificial intelligence components. Controllers may also contain monitoring segments for specific functions.

One controller function is dedicated to the Energy Cycle Drive Train, controlling which storage cell(s) will be charged, which will dissipate energy, and which will be in standby mode, if any.

Another controller function coordinates propulsion with the Axle Generators and switching back and forth when appropriate between the axle generators and other methods of propulsion available to the vehicle, such as gasoline or battery.

Said coordination includes determining when and controlling that the vehicle is in continuous driving mode; determining when and controlling initiation and termination of the Energy Cycle Drive Train utility; determining when and controlling which energy source to use that is different from the Axle Generators and its Energy Cycle Drive Train; and determine when and controlling the use of energy accumulated from regeneration resulting from deceleration and braking of the vehicle

Yet another controller function directs the IRVS functions, coordinating and monitoring the number of the IRVS units and the revolutions per minutes desired for each drive function of the vehicle.

Yet another controller function determines the amount of energy available for transmission to an outside destination, such as the national grid, controlling and logging such data as the transmitted amount, transmission location, transmission destination, day and time of transmission

Thus, besides transmission of energy to outside destinations, the controller system governs a comprehensive mobility strategy for the vehicle, allowing for optimal usage of resources that may include, Axle Generators, energy regeneration and other suitable propulsion methods available to the vehicle.

At least one of several possible gauges may be installed in the vehicle for the purpose of monitoring amounts of energy generated, dissipated and lost to such factors as heat and enable an unbiased assessment of an average miles per gallon driven or its equivalent on variety of terrains. Further, at least one of several possible gauges may be installed to monitor functioning of components and alert of any existing or potential malfunctioning of said component(s) in the vehicle.

The same principle of said alternative energy utilized as Axle Generators in vehicles may also be utilized in other cases where there is a rotating part while there also exists another part at rest. One such case is an elevator moving up and down in a fixed shaft.

It should be noted that an elevator moving up and down in a shaft does so at a relative slow speed that is not suitable for generating meaningful electrical energy. However, when the IRVS system, properly adjusted to the elevator construct is utilized, it enables a higher rotational velocity and generation of energy. In one embodiment of such an elevator, the pulleys hoisting the elevator cars as they rotate are fitted with at least one IRVS system(s) that may be connected in a successive way so increase the rotational velocity of the last pinion gear. The last pinion gear in the operational IRVS system is fixed with or connects to a part that is fixed with permanent magnets that may be mounted on a rod extending from said final pinion. A stator with conductive wires that may engulf said rod with magnets allows for the electrical wires to cut into the changing magnetic field occurring on account to the rotation resulting in electricity flowing in the coils. Since the motor in elevators does not bear all the lifting and creating of the potential energy due to the weights counterbalancing the weight in the elevator car, its energy requirement are reduced. Such energy requirement may further be reduced when the technology disclosed herein is added to the elevator construct. Such saving in energy may be both economical as well as contributing to cleaner energy consumption for said motor. Further, such energy generated by elevators could reduce the need for constructs, such as buildings and hotels to rely on externally supplied energy for elevator operation. When sufficient energy is so generated it may be stored in a storage device(s) and utilized for other suitable purposes in said constructs, such as buildings and hotels.

Another embodiment for the cylinder where the calcium carbide is in liquefied form rather than solid is hereby introduced. In that regard, the container housing it will be adjusted both in form and location. The form would be for the housing and release of the CaC₂ liquid and the housing would be elevated compared to where it was before, so that it is above the water level in the cylinder, enabling the CaC₂ to drip at the quantities and timing needed to create the appropriate combustion. Also, in some embodiments water and calcium carbide can be used for production of electricity in power plants and for any generation of power needed.

A suitable controller may adjust the amount and frequency of droplets into the water tank. A proper barrier with suitable redundancy may be constructed with the purpose of shielding the water from inadvertent connection with the CaC₂ upon unexpected situations, such as vehicle collision or an earthquake, such as when it is used for power generation in a plant.

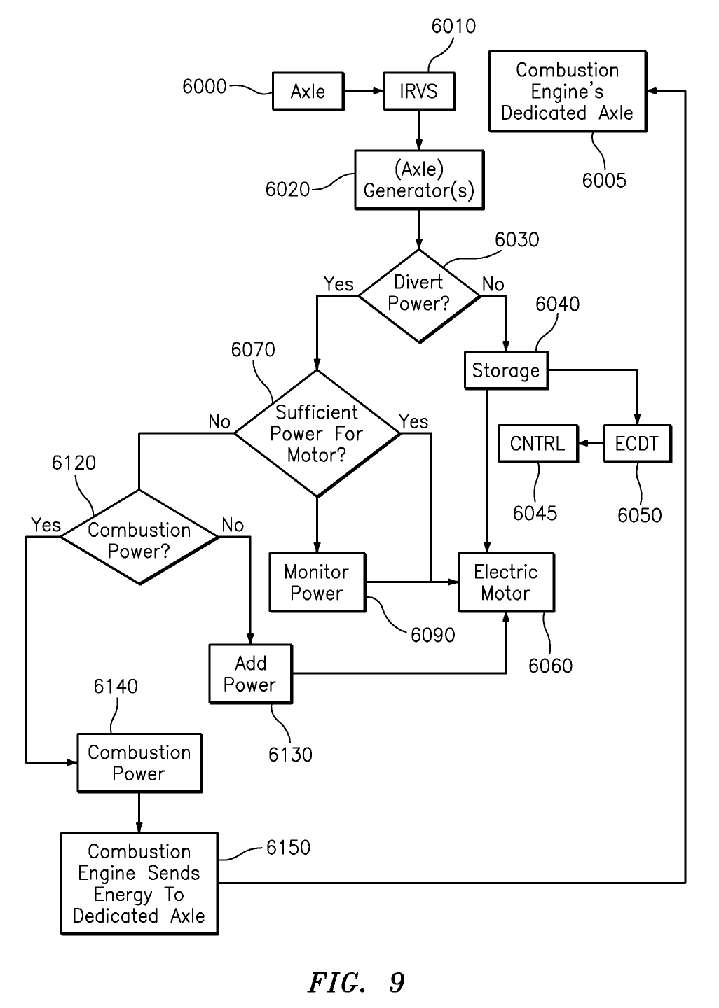

FIG. 9 illustrates the axle generation of energy in a vehicle. The axle(s) (6000) designated for energy generation in the vehicle rotate and connect(s) to the IRVS system (6010) where the rotations are increased. The IRVS (6010) is connected to the generator (6020) where the energy is generated. In step (6030), the generator is queried if the energy is to be transmitted directly to the electric motor. If the answer is negative, the energy is stored in storage (6040) and released to the electric motor (6060) for driving activity under the controller (6045) that oversees the Energy Cycle Drive Train (ECDT) (6050) activity. If the answer to the query in step (6030) is affirmative, it is queried in step (6070) if the power coming from the axle generators is sufficient to drive the electric motor for the desired purpose. If the answer is affirmative, the power flows into the electric motor (6060) and is continuously monitored by monitor (6090) to ascertain sufficient power delivery. However, if the answer in step (6070) is negative, it is checked in step (6120) to see if the power could sufficiently be augmented by other energy sources in the vehicle to reach the level required for the electric motor (6060) or utilize combustion energy. If the answer is affirmative for other energies, and negative for the combustion engine, then additional energy is added in step (6130) and sent to the electric motor (6060). However, if it is determined in step (6120) that said added energy would not reach the level of needed energy for the motor, the combustion engine (6140) is utilized and delivers the needed power (6150) to the axle dedicated for mobility by the combustion engine (6005). The various queries may be performed by a pre-programmed computer.

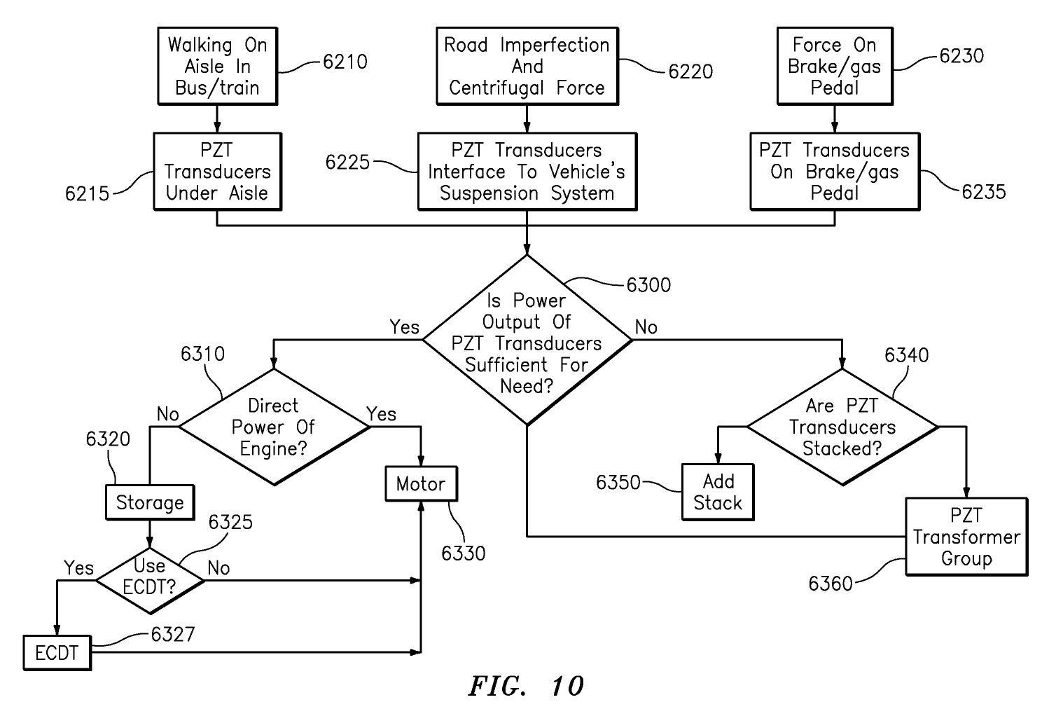

FIG. 10 illustrates piezoelectric energy generation in a vehicle. Pressure on piezoelectric inducers in a vehicle can come from a variety of location such as from force applied to the brake and/or gas pedal (6230), a force applied from individuals walking in the aisle between seats (6210), or from road imperfections and centrifugal force on the suspension system (6220). The force from walking in the aisle may be applied to piezoelectric transducers (6215) laid out underneath the trodden path. The force on the brake and/or gas pedal may be applied to PZT transducers (6235) positioned on the brake and/or gas pedal; and PZT transducers (6225) are positioned behind a protective plate and interface to the suspension system. Any one and all of the three demonstrated possibilities to generate piezoelectric energy in is/are checked in step (6300) to see if the generated power output form the PZT transducers is sufficient for the designated need. If affirmative, it is queried in step (6310) if the energy is designated for directly powering the engine without going through a storage facility. If the answer to that is affirmative the energy moves to the electric motor (6330). However, if the answer is negative, the energy moves to storage (6320). Subsequently, once in storage, it is queried in step (6325) if energy should dissipate through the Energy Cycle Drive Train. If the answer is negative, the energy moves directly from said storage to the electric motor (6330). However, if affirmative, the energy goes through the ECDT (6327) on its way to the electric motor (6330). The various queries may be performed by a pre-programmed computer.

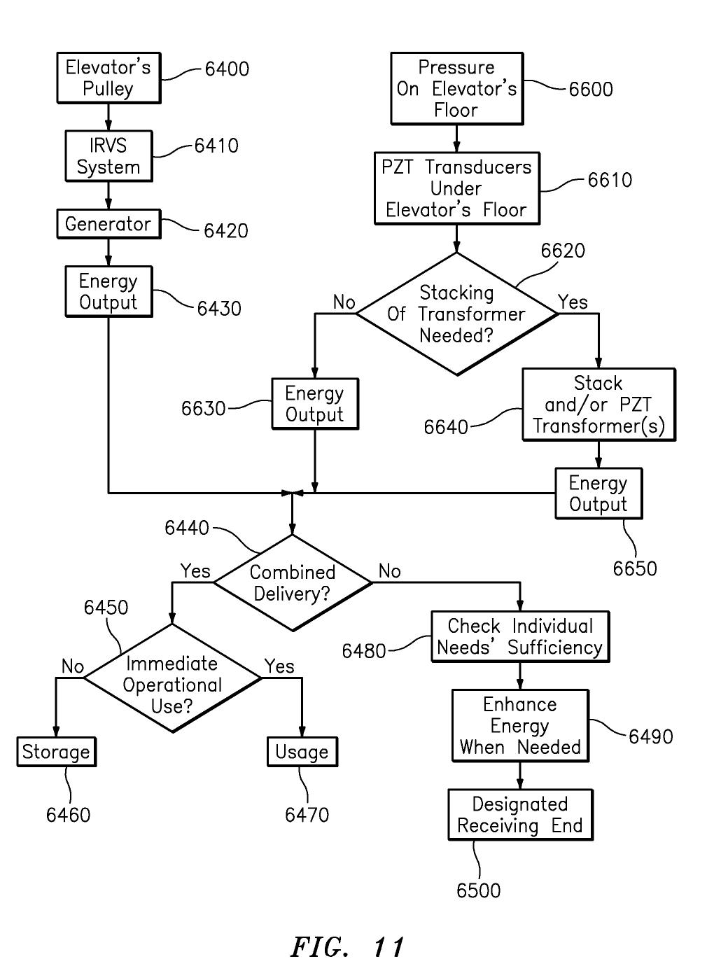

FIG. 11 illustrates generation of alternative energy for elevators. There are two sources of such alternative energy. One source comes from the elevator's pulley (6400) and the other from the pressure of a person's feet on the elevator's floor (6600) that becomes increased as it ascends, due to gravity. The pulley (6400) activates the IRVS (6410), which in turn provides the generator (6420) with rotational velocity so energy is produced and the output is ready for collection in collection device (6430). The pressure (6600) is applied to PZT transducers (6610). In step (6620) it is queried if it is required to enhance the output from the PZT transducer by stacking up at least more than one or pass the output energy through a series of at least one PZT transformer, or do both. If the answer is affirmative, the output energy is enhanced in step (6640) by either stacking up PZT transducers, passing output(s) through PZT transformers, or do a combination of both. The energy output is ready for collection in collection device (6650). If the answer to the query in step (6620) is negative, the energy is ready for collection in collection device (6630). In step (6440) it is queried if the energy ready for collection from at least two of the collection devices (6430), (6630) and (6650) should be combined in its delivery. If the answer is negative, then in step (6480) each individual output is examined as to being sufficient for the delivery needs. Those that are found to be of insufficient energy undergo enhancement in step (6490) before they end up at the designated receiving end in step (6500). If the query in step (6440) turns affirmative, it is then queried in step (6450) if the energy is needed for operational use. If the answer is affirmative, it is released for usage in step (6470), and otherwise, if the answer is negative, it goes to storage in storage (6460). All queries may be performed by a pre-programmed computer.

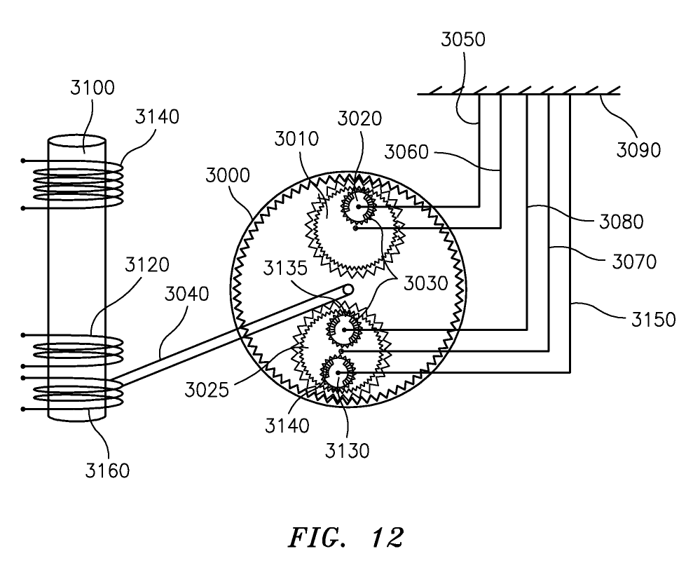

FIG. 12 illustrates the IRVS principle. A primary sprocket (3000) has teeth on the inside that activates a secondary double-layer inverted sprocket (3010). The secondary sprocket (3010) activates a tertiary sprocket (3020) that has permanent magnets (3030) affixed to it. Upon the rotation of the axle (3040), the primary sprocket (3000) rotates at the same speed as the axle (3040). This causes the secondary sprocket (3010) to rotate at twice the speed of the axle (3040). The secondary sprocket (3010) activates the tertiary sprocket (3020) that rotates at twice the speed of the secondary sprocket (3010) or four times the speed of the axle (3040). The magnets (3030) create a magnetic field that is cut through by the conductor coils (3110) looped around a stator (3110) that may be affixed to any suitable part in the vehicle, such as to the shock absorber (3100). Electricity flows as a result in the conductors (3110). The secondary sprocket (3010) is attached via a bracket (3060) to the chassis (3090) and the tertiary sprocket (3020) is attached to the chassis (3090) by a bracket (3050).

The secondary sprocket (3025) activates two tertiary sprockets, one with magnets (3030) or affixed to it and another tertiary sprocket (3130) with magnets (3140) or affixed to it. This enables the creating of electricity in two separate sets of conducting coils, (3120) and (3160) that may be affixed to any suitable part in the vehicle, such as the shock absorber (3100). The secondary sprocket (3025) is affixed to the chassis (3090) via a bracket (3070). The tertiary sprocket (3030) is affixed to the chassis (3090) by the bracket (3080) and the tertiary sprocket (3130) is affixed to the chassis (3090) via the bracket (3150).

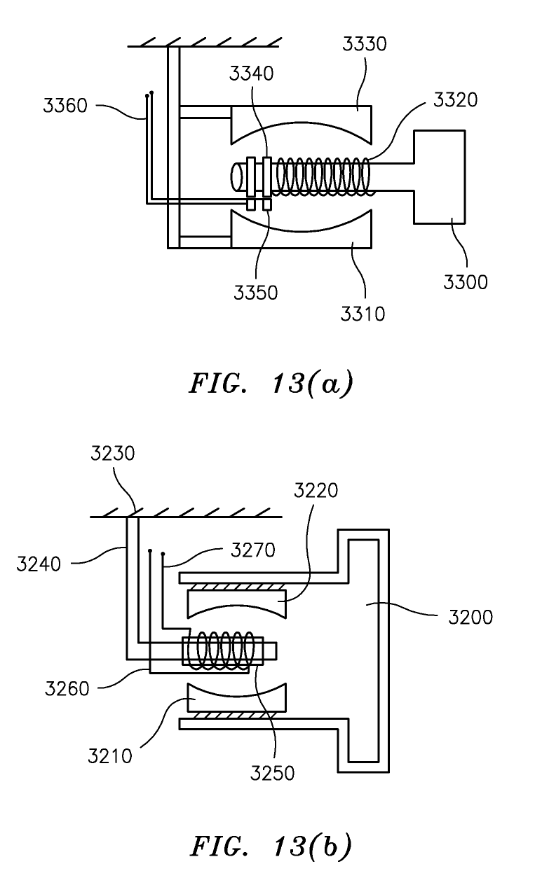

FIGS. 13(a) and 13(b) illustrate two possible options for axle generators and their relation to the IRVS.

When the magnets rotate as shown in FIGS. 13(a) and 13(b), the tertiary Sprocket (3200) rotates with a velocity that is twice that of the secondary sprocket and 4 times the velocity of the primary sprocket. The concave cylindrical magnets (3220) and (3210) are attached to the sprocket (3200) and rotate with it. The bracket (3240) is attached to the chassis (3230) and has an armature (3250) attached to it as a sleeve on which there is wound a coil (3260) where it terminates (3270).

When the armature rotates, as shown in FIG. 13(a), the tertiary sprocket (3300) has either coil (3320) wound on it in (3320) or on a sleeve (not shown). The armature has metal slip rings (3340) insulated from each other, and carbon brushes (3350) that deliver the electricity that terminates at leads (3360). The bracket (3370) is attached to the chassis (3230) and has fixed magnets (3310) and (3330) attached to the bracket (3370) inside which the sprocket (3300) rotates and thereby causes the coil (3320) to rotate as well and thereby have current flowing in it terminating in leads (3360).

As can be seen from the foregoing description, alternative energy generation systems for use with vehicles, for supplying energy to the national grid and generating energy for other purposes have been provided. While the present invention has been described in the context of specific embodiments thereof, other alternatives, modifications, and variations may become apparent to those skilled in the art having read the foregoing description. Accordingly, it is intended to embrace those alternatives, modifications, and variations.

The vehicle may benefit from diagnostic of various forms, and specifically diagnostics with remote monitoring. Electronic monitoring of the various components to facilitate diagnostics (both after a failure as well as preventative, announcing a possible situation that is about or could happen) may be installed on board of the vehicle. This may be a Real Time monitoring with wireless option(s). It may be in concert with the controller(s) on board of the vehicle or as an integral part of such controller(s). Further, diagnostics may be equipped with remote monitoring, such as by wireless, as well as fixing problems if possible from a remote location, using such program(s) as PC Anywhere. Items that may be monitored are the conducting coils, magnets in place, sprockets or gears rotating appropriately, ultracapacitors functioning, being suitably charged and letting charge dissipate at correct amounts, the ultracapacitors properly cyclic moving for recharge standby and dissipating energy, The Energy Cycle Drive Train, proper loads to the motor for enough torque and the controller(s) themselves (which means an independent part of it not being part of the controller(s).

As can be seen from the foregoing description, alternative energy generation systems for use with vehicles have been provided. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed is:

1. A system for generating energy comprising:
a vehicle with at least one of an axle and at least one wheel; and
means associated with said at least one of an axle and at least one wheel for generating electricity as said wheels rotate.

2. The system of claim 1, wherein said means for generating electricity comprises at least one permanent magnet attached to each said at least one of an axle and at least one wheel and at least one stationary armature with at least one conductor located in sufficient proximity to said magnet to cut through its magnetic field.

3. The system of claim 1, wherein said means for generating electricity comprises at least one armature with at least one conductor attached to each wheel and at least one stationary permanent magnet located in close proximity to each said wheel, wherein said at least one conductor cuts through the magnetic field of said magnet as the said wheel rotates.

4. The system of claim 1, further comprising means for collecting energy generated by said generating means.

5. The system of claim 4, further comprising means for transferring energy from said collecting means to an energy collection depot.

6. The system of claim 5, wherein said energy collection depot is located in at least one of a private and public parking area.

7. The system of claim 6, further comprising means for providing an operator of said vehicle with at least one of a voucher and credit for electricity transferred to said energy collection depot.

8. The system of claim 1, further comprising means for converting a portion of said AC electricity to DC energy and for using said at least one of a DC and AC energy to drive a propulsion device on said vehicle and means for storing at least one of an AC and a DC energy component of said electricity.

9. The system of claim 8, further comprising means for using at least some of said AC energy to charge a flywheel and/or recharge at least one battery on said vehicle.

10. The system of claim 1, wherein each of said wheels is attached to an axle and said electricity generating means comprises at least one magnet mounted to said axle and a coil of conducting wires in close proximity to said at least one magnet so that said coil cuts through a magnetic field created by said at least one magnet as said axle rotates.

11. The system of claim 10, wherein said axle has a single magnet which covers the entire axle.

12. The system of claim 10, wherein each said axle has at least three magnets spaced along its length.

13. The system of claim 1, wherein each of said wheels is attached to an axle and said electricity generating means comprises a coil of conducting wires attached to each said axle and at least one magnet mounted in close proximity to said axle so that said coil of conducting wires cuts through a magnetic field created by said at least one magnet as said axle rotates.

14. The system of claim 1, wherein each of said wheels is attached to an axle and said electricity generating means comprises at least one worm gear segment on each said axle and a secondary gear attached to a generator for generating electricity, which secondary gear has a plurality of teeth which contact said at least one worm gear segment so that when said axle rotates said secondary gear rotates.

15. The system of claim 14, wherein each said axle has a plurality of spaced apart worm gear segments and a plurality of said secondary gears attached to a plurality of generators.

16. The system of claim 15, wherein each said generator is attached to at least one of an aggregator and at least one of a flywheel and battery.

17. The system of claim 16, wherein each said generator provides electricity to at least one of a flywheel and a battery and said electricity is used to drive an engine for propelling the vehicle.

18. The system of claim 1, further comprising a cart having said plurality of wheels and a plurality of axles connecting said wheels and said electricity generating means comprises at least one worm gear segment on each said axle, at least one secondary gear having teeth cooperating with said at least one worm gear segment, and at least one generator connected to each said secondary gear.

19. The system of claim 18, wherein said axle has a plurality of worm gear segments and at least one secondary gear having teeth cooperating with each said worm gear segment.

20. The system of claim 19, further comprising at least one of a flywheel and a battery for receiving electricity from each said generator and an engine driven by current from said at least one of a flywheel and a battery.

21. The system of claim 1, further comprising each said wheel being attached to an axle having a threaded portion and said electrical generating means comprising a plurality of secondary gears having teeth which interact with the threaded portion on said axle and a plurality of generators attached to said secondary gears.

22. The system of claim 21, further comprising an aggregator and controller attached to said generators, at least one flywheel for storing part of the at least one of the DC or AC energy in the aggregator and controller, and means for converting a portion of the AC energy into DC energy and at least one of a battery bank and a flywheel bank for receiving and storing said DC energy.

23. The system of claim 22, further comprising an engine for propelling said vehicle and said engine receiving at least one of DC and AC energy from said flywheel and AC energy from a DC to AC converter connected to said battery bank.

24. The system of claim 23, wherein said engine comprises at least one of a DC and AC motor.

25. The system of claim 23, further comprising a noise management system and means for cleaning and oiling the threaded axle.

26. A system for providing energy to a vehicle comprising:
an engine having at least one cylinder and at least one piston positioned within said at least one cylinder for movement relative to said at least one cylinder; and
means for creating an explosive force within said at least one cylinder which causes said at least one piston to move relative to said at least one cylinder, said explosive force creating means comprising means for creating acetylene.

27. The system of claim 26, wherein said acetylene creating means comprises means for mixing calcium carbide with water.

28. The system of claim 26, wherein said acetylene creating means includes means for triggering said explosive force by at least one of a spark, mechanical force and heat.

29. The system of claim 26, wherein said acetylene creating means comprises means for spraying water into said at least one cylinder so as to form a mist and means for injecting said carbide into said mist.

30. The system of claim 26, further comprising a chamber wherein the acetylene is produced and means for conducting said acetylene to a chamber of said at least one cylinder.

31. The system of claim 30, further comprising an envelope surrounding said chamber and a portion of said cylinder and said envelope being filled with one of acetone and acetic acid.

32. The system of claim 26, wherein said means for creating acetylene comprises means for supplying water to a chamber in said at least one cylinder and means for supplying calcium carbide to said chamber.

33. The system of claim 32, further comprising an envelope surrounding at least a portion of said at least one cylinder and said envelope containing one of acetone and acetic acid.
